(19) United States
(12) Patent Application Publication
(10) Pub. No.: US 2013/0164478 A1
(43) Pub. Date: Jun. 27, 2013

(54) DOUBLE-FACED PRESSURE-SENSITIVE ADHESIVE SHEET, DOUBLE-FACED PRESSURE-SENSITIVE ADHESIVE SHEET WITH RELEASE SHEET, PROCESS FOR PRODUCING SAME, AND TRANSPARENT LAMINATE

(71) Applicants: Masayuki Yamamoto, Mitoyo-shi (JP); Yohei Nakamura, Koto-ku (JP); Kuniaki Muto, Mitoyo-shi (JP); Yasufumi Sumitomo, Mitoyo-shi (JP)

(72) Inventors: Masayuki Yamamoto, Mitoyo-shi (JP); Yohei Nakamura, Koto-ku (JP); Kuniaki Muto, Mitoyo-shi (JP); Yasufumi Sumitomo, Mitoyo-shi (JP)

(73) Assignees: OJI HOLDINGS CORPORATION, TOKYO (JP); NEW TAC KASEI CO., LTD., SHIKOKUCHUO-SHI, EHIME (JP)

(21) Appl. No.: 13/813,925

(22) PCT Filed: Aug. 3, 2011
(86) PCT No.: PCT/JP2011/067805

§ 371 Date: Feb. 1, 2013

(30) Foreign Application Priority Data
Aug. 5, 2010 (JP) 2010-176479
Dec. 22, 2010 (JP) 2010-286642
Feb. 14, 2011 (JP) 2011-028395

(51) Int. Cl. C09J 7/00; B32B 27/00; B32B 7/12

(52) U.S. Cl. CPC C09J 7/00; B32B 7/12; B32B 27/00
USPC 428/41.8; 428/355 AC; 428/214; 428/172; 428/335

(57) ABSTRACT

A double-faced pressure-sensitive adhesive sheet, including a first pressure-sensitive adhesive layer, and a second pressure-sensitive adhesive layer provided on one side of the aforementioned first pressure-sensitive adhesive layer, wherein a primary component of the first pressure-sensitive adhesive layer is a two-part acrylic pressure-sensitive adhesive (I), and a weight average molecular weight of the pertinent two-part acrylic pressure-sensitive adhesive (I) is 150,000-800,000, and wherein a primary component of the second pressure-sensitive adhesive layer is a two-part acrylic pressure-sensitive adhesive (II), and a weight average molecular weight of the pertinent two-part acrylic pressure-sensitive adhesive (II) is 900,000-2,000,000.

### TECHNICAL FIELD

The present invention relates in particular to a double-faced pressure-sensitive adhesive sheet which does not have a substrate within a pressure-sensitive adhesive layer, a double-faced pressure-sensitive adhesive sheet with a release sheet, a process for producing the same, and a transparent laminate using the pertinent double-faced pressure-sensitive adhesive sheet.

Priority is claimed on Japanese Patent Application No. 2010-176479, filed Aug. 5, 2010, Japanese Patent Application No. 2010-286642, filed Dec. 22, 2010, and Japanese Patent Application No. 2011-028395, filed Feb. 14, 2011, the content of which is incorporated herein by reference.

### BACKGROUND ART

Double-faced pressure-sensitive adhesive sheets are used for bonding of a variety of members. Among these, as transparency is obtainable with double-faced pressure-sensitive adhesive sheets that do not have a substrate within the pressure-sensitive adhesive layer, such sheets are used for adhesion of optical parts—e.g., for bonding of an apparatus to detect an input and a front plate disposed on a front side of the pertinent apparatus to detect an input when manufacturing touchscreens (see, e.g., Patent Document 1). Double-faced pressure-sensitive adhesive sheets are also used for bonding of an apparatus to detect an input and an image display panel disposed underneath it (liquid crystal panels, plasma display panels, and organic electroluminescent panels).

Due to their superior optical properties, polycarbonate sheets, polymethyl methacrylate sheets, or polyethylene terephthalate sheets are widely used as the front plate and substrate of optical parts to be bonded by a double-faced pressure-sensitive adhesive sheet.

Moreover, in the case where an apparatus to detect an input and a liquid crystal panel are to be bonded by a double-faced pressure-sensitive adhesive sheet, the double-faced pressure-sensitive adhesive sheet is bonded to the substrate of a polarizing plate which is a part of the liquid crystal panel. Triacetyl cellulose sheets and cycloolefin polymer sheets are widely used as polarizing plate substrates.

### PRIOR ART REFERENCES

### Patent Documents

Patent Document 1: Japanese Unexamined Patent Application, First Publication No. 2010-77287

### DISCLOSURE OF INVENTION

### Problems that the Invention is to Solve

Now, ordinarily, after an optical part has bonded to a polycarbonate sheet, polymethyl methacrylate sheet or polyethylene terephthalate sheet with interposition of a double-faced pressure-sensitive adhesive sheet, heat treatment is conducted, whereupon, in the case of a polycarbonate sheet or a polymethyl methacrylate sheet, gas may be generated from the substrate thereof. When gas collects between the polycarbonate sheet or the polymethyl methacrylate sheet and the double-faced pressure-sensitive adhesive sheet, so-called “swelling” may arise. With respect to a triacetyl cellulose sheet used in a polarizing plate, release of moisture may occur due to changes in environmental humidity.

Consequently, in the case where a triacetyl cellulose sheet of a polarizing plate configuring a liquid crystal panel and an apparatus to detect an input are bonded by a double-faced pressure-sensitive adhesive sheet, “swelling” may occur between the triacetyl cellulose sheet and the double-faced pressure-sensitive adhesive sheet due to released moisture.

It is thought that a pressure-sensitive adhesive of high cohesive strength inhibits occurrence of “swelling.” However, when an optical member composed of material with a different thermal expansion and contraction rate is bonded with a polycarbonate sheet, a polymethyl methacrylate sheet, or a polyethylene terephthalate sheet via a double-faced pressure-sensitive adhesive sheet wherein the pressure-sensitive adhesive layer is composed of the pertinent pressure-sensitive adhesive, curling may occur due to heat treatment, because of the extremely high cohesive strength of the pressure-sensitive adhesive inhibiting deformation.

On the other hand, the double-faced pressure-sensitive adhesive sheet may be subjected to punching in conformity with the size of a touchscreens member, and in the case of a pressure-sensitive adhesive with a low cohesive strength that does not cause curling by heat treatment, work problems frequently occur such as adhesion of the pressure-sensitive adhesive to the cutting blade.

As a result of such problems, there is a demand for a double-faced pressure-sensitive adhesive sheet which can prevent occurrence of swelling, inhibit curling, and exhibit excellent work production during punching.

The surface to which a double-faced pressure-sensitive adhesive sheet adheres is not necessarily planar, and may also be formed with irregularities. Consequently, there is also demand for double-faced pressure-sensitive adhesive sheets which exhibit the conformance to irregularities so that there is close adherence to an uneven surface without interstices.

Upon study by the present inventors, it was found that prevention of swelling is facilitated when cohesive strength is raised by using material with a large average molecular weight as the pressure-sensitive adhesive of the double-faced pressure-sensitive adhesive sheet. However, when a pressure-sensitive adhesive of large average molecular weight is used, the consentration of the coating color may be reduced, because the viscosity of the coating color that serves to form the pressure-sensitive adhesive layer tends to increase. When the consentration of the coating color declines, it is difficult to conduct thick coating, with the result that the pressure-sensitive adhesive layer thins, the conformance to irregularities declines as the pressure-sensitive adhesive layer thins, and there is a tendency for curling to occur when there is adhesion to material with a different thermal expansion and contraction rate.

The present invention was made in light of the foregoing circumstances, and its object is to offer a double-faced pressure-sensitive adhesive sheet with excellent swelling prevention properties, curling prevention properties, punching workability, and the conformance to irregularities, as well as a double-faced pressure-sensitive adhesive sheet with release sheet that is provided with the pertinent double-faced pressure-sensitive adhesive sheet, and a transparent laminate. Another object of the present invention is to offer a manufacturing method useful for manufacture of the aforementioned double-faced pressure-sensitive adhesive sheet with release sheet.

### Means for Solving the Problems

The present invention was made based on the foregoing findings, and has the following modes.

[1] A double-faced pressure-sensitive adhesive sheet, comprising a first pressure-sensitive adhesive layer, and a second pressure-sensitive adhesive layer provided on one side of said first pressure-sensitive adhesive layer, wherein a primary component of the first pressure-sensitive adhesive layer is a two-part acrylic pressure-sensitive adhesive (I), and a weight average molecular weight of said two-part acrylic pressure-sensitive adhesive (I) is 150,000-800,000, and wherein a primary component of the second pressure-sensitive adhesive layer is a two-part acrylic pressure-sensitive adhesive (II), and a weight average molecular weight of said two-part acrylic pressure-sensitive adhesive (II) is 900,000-2,000,000.
[2] The double-faced pressure-sensitive adhesive sheet according to [1], wherein a weight average molecular weight of the two-part acrylic pressure-sensitive adhesive (I) is 350,000-800,000.
[3] The double-faced pressure-sensitive adhesive sheet according to [1] or [2], wherein a thickness of the first pressure-sensitive adhesive layer is 1.5-fold to 100-fold of a thickness of the second pressure-sensitive adhesive layer.
[4] The double-faced pressure-sensitive adhesive sheet according to [3], wherein a thickness of the first pressure-sensitive adhesive layer is 20-500 μm.
[5] The double-faced pressure-sensitive adhesive sheet according to [3] or [4], wherein a thickness of the second pressure-sensitive adhesive layer is 5-50 μm.
[6] A double-faced pressure-sensitive adhesive sheet with release sheet, wherein a release sheet is laminated onto at least one surface of the double-faced pressure-sensitive adhesive sheet according to [1] or [2].
[7] A method of manufacture of the double-faced pressure-sensitive adhesive sheet with release sheet according to [6], comprising: a step in which coating color to form a first pressure-sensitive adhesive layer containing a crosslinking agent and an acrylic polymer with a weight average molecular weight of 150,000-800,000 and coating color to form a second pressure-sensitive adhesive layer containing a crosslinking agent and an acrylic polymer with a weight average molecular weight of 900,000-2,000,000 are simultaneously multilayer coated onto a release sheet, and heating is conducted to form said double-faced pressure-sensitive adhesive sheet.
[8] A transparent laminate in which a first transparent substrate and a second transparent substrate are bonded by the double-faced pressure-sensitive adhesive sheet according to [1] or [2], and in which the first pressure-sensitive adhesive layer contacts the first transparent substrate, and the second pressure-sensitive adhesive layer contacts the second transparent substrate, wherein at least one or the other of the first transparent substrate and the second transparent substrate have irregularities formed on a surface on the double-faced pressure-sensitive adhesive sheet side, and the second transparent substrate is any one of a polycarbonate monolayer sheet, a polymethyl methacrylate monolayer sheet, a polycarbonate-polymethyl methacrylate laminar sheet, a triacetyl cellulose sheet, or a cycloolefin polymer sheet.
[9] The double-faced pressure-sensitive adhesive sheet according to [1] or [2], wherein a third pressure-sensitive adhesive layer is provided on a surface on the opposite side of the surface of the first pressure-sensitive adhesive layer on which the second pressure-sensitive adhesive layer is provided, and a primary component of said third pressure-sensitive adhesive layer is a two-part acrylic pressure-sensitive adhesive (III), a weight average molecular weight of the pertinent two-part acrylic pressure-sensitive adhesive (III) is 900,000-2,000,000, and a thickness of the second pressure-sensitive adhesive layer is 5-50 μm.
[10] The double-faced pressure-sensitive adhesive sheet according to [9], wherein a thickness of the first pressure-sensitive adhesive layer is 1.5-fold to 100-fold of a thickness of the second pressure-sensitive adhesive layer.
[11] The double-faced pressure-sensitive adhesive sheet according to [10], wherein a thickness of the first pressure-sensitive adhesive layer is 20-500 μm.
[12] The double-faced pressure-sensitive adhesive sheet according to any of [9]-[11], wherein a thickness of the third pressure-sensitive adhesive layer is 5-50 μm.
[13] A double-faced pressure-sensitive adhesive sheet with release sheet, wherein a release sheet is laminated onto at least one surface of the double-faced pressure-sensitive adhesive sheet according to [9].
[14] A method of manufacture of the double-faced pressure-sensitive adhesive sheet with release sheet according to [13], comprising: a step in which coating color to form a first pressure-sensitive adhesive layer containing a crosslinking agent and an acrylic polymer with a weight of average molecular weight of 150,000-800,000, coating color color to form a second pressure-sensitive adhesive layer containing a crosslinking agent and an acrylic polymer with a weight average molecular weight of 900,000-2,000,000, and coating color to form a third pressure-sensitive adhesive layer containing a crosslinking agent and an acrylic polymer with a weight average molecular weight of 900,000-2,000,000 are simultaneously multilayer coated onto a release sheet, and heating is conducted to form said double-faced pressure-sensitive adhesive sheet.
[15] A transparent laminate in which a first transparent substrate and a second transparent substrate are bonded by the double-faced pressure-sensitive adhesive sheet according to [9], and in which the second pressure-sensitive adhesive layer contacts the first transparent substrate, and the third pressure-sensitive adhesive layer contacts the second transparent substrate; wherein at least one or the other of the first transparent substrate and the second transparent substrate have irregularities formed on a surface on the double-faced pressure-sensitive adhesive sheet side, and at least one or the other of the first transparent substrate and the second transparent substrate is composed of polycarbonate, polymethyl methacrylate, polyethylene terephthalate, triacetyl cellulose, or cycloolefin polymer.

### Effects of the Invention

According to the present invention, it is possible to offer a double-faced pressure-sensitive adhesive sheet with excellent swelling prevention properties, curling prevention properties, punching workability, and the conformance to irregularities, as well as a double-faced pressure-sensitive adhesive sheet with release sheet that is provided with the pertinent double-faced pressure-sensitive adhesive sheet, and a transparent laminate. With respect to the pertinent transparent laminate, the double-faced pressure-sensitive adhesive sheet closely adheres with a high degree of adhesiveness to an irregular surface of a transparent substrate.

According to the present invention, it is possible to offer a manufacturing method useful for manufacture of the aforementioned double-faced pressure-sensitive adhesive sheet with release sheet.

### BRIEF DESCRIPTION OF THE DRAWINGS

FIG. 1 is a cross-sectional view which shows an embodiment of the double-faced pressure-sensitive adhesive sheet of the present invention.

FIG. 2 is a cross-sectional view which shows an embodiment of the double-faced pressure-sensitive adhesive sheet with release sheet of the present invention.

FIG. 3 is a cross-sectional view which shows an embodiment of the transparent laminate of the present invention.

FIG. 4 is a cross-sectional view which shows another embodiment of the double-faced pressure-sensitive adhesive sheet of the present invention.

FIG. 5 is a cross-sectional view which shows another embodiment of the double-faced pressure-sensitive adhesive sheet with release sheet of the present invention.

FIG. 6 is a cross-sectional view which shows another embodiment of the transparent laminate of the present invention.

### MODE FOR CARRYING OUT THE INVENTION

### Double-Faced Pressure-Sensitive Adhesive Sheet 110

One embodiment of the double-faced pressure-sensitive adhesive sheet of the present invention is now described.

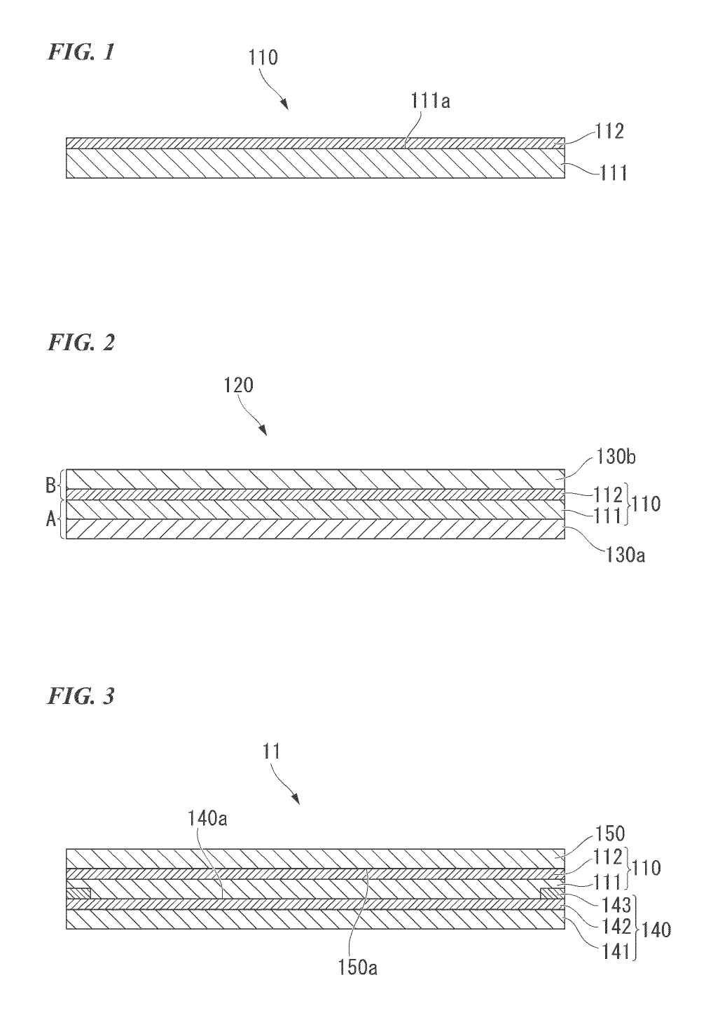

FIG. 1 shows the double-faced pressure-sensitive adhesive sheet of the present embodiment. A double-faced pressure-sensitive adhesive sheet 110 of the present embodiment is provided with a first pressure-sensitive adhesive layer 111 and a second pressure-sensitive adhesive layer 112 which is provided so as to contact one surface 111a of the first pressure-sensitive adhesive layer 111.

<Double-Faced Pressure-Sensitive Adhesive Sheet 210>

Another embodiment of the double-faced pressure-sensitive adhesive sheet of the present invention is now described.

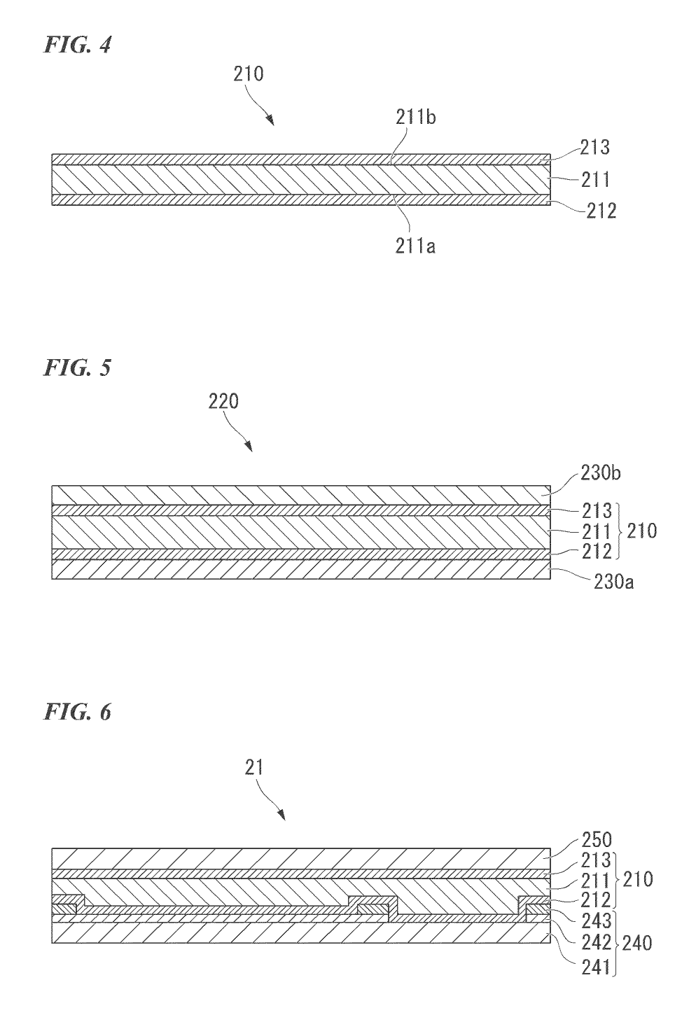

FIG. 4 shows the double-faced pressure-sensitive adhesive sheet of the present embodiment. A double-faced pressure-sensitive adhesive sheet 210 of the present embodiment is provided with a first pressure-sensitive adhesive layer 211, a second pressure-sensitive adhesive layer 212 which is provided so as to contact one surface 211a of the first pressure-sensitive adhesive layer 211, and a third pressure-sensitive adhesive layer 213 which is provided so as to contact a surface 211b of the first pressure-sensitive adhesive layer 211 that is on the side opposite the second pressure-sensitive adhesive layer 212 side.

(First Pressure-Sensitive Adhesive Layer 111)

The primary component of the first pressure-sensitive adhesive layer 111 is a two-part acrylic pressure-sensitive adhesive.

In the present invention, with respect to a “two-part acrylic pressure-sensitive adhesive”, acrylic polymers are crosslinked by a crosslinking agent. “Primary component” indicates 50 weight % or more relative to the overall pressure-sensitive adhesive layer.

Furthermore, with respect to the point of further enhancement of the conformance to irregularities, the proportion of the two-part acrylic pressure-sensitive adhesive (I) relative to the entire first pressure-sensitive adhesive layer 111 is preferably 70 weight % or more, and is more preferably 90 weight % or more.

(First Pressure-Sensitive Adhesive Layer 211)

The primary component of the first pressure-sensitive adhesive layer 211 is a two-part acrylic pressure-sensitive adhesive.

In the present invention, with respect to a “two-part acrylic pressure-sensitive adhesive”, acrylic polymers are crosslinked by a crosslinking agent. “Primary component” indicates 40 weight % or more relative to the overall pressure-sensitive adhesive layer.

Furthermore, with respect to the point of further enhancement of curling prevention performance and the conformance to irregularities, the proportion of the two-part acrylic pressure-sensitive adhesive (I) relative to the entire first pressure-sensitive adhesive layer 211 is preferably 50 weight % or more, and is more preferably 70 weight % or more.

Acrylic Polymer

The acrylic polymer is a polymer having non-crosslinking acrylic monomer units and crosslinking monomer units.

Here, “monomer unit” is a repeating unit constituting a polymer. “Acrylic monomer” is a compound having a (meth)acryloyl group. “(Meth)acryloyl group” indicates that there is an acrylolyl or methacryloyl group. A non-crosslinking acrylic monomer is an acrylic monomer without crosslinking groups, and a crosslinking monomer is a monomer having crosslinking groups. Crosslinking monomers may be acrylic monomers or non-acrylic monomers provided that they are capable of polymerizing with non-crosslinking acrylic monomers, but acrylic monomers are preferable.

As crosslinking groups, one may cite carboxy groups, hydroxy groups, amino groups, epoxy groups, glycidyl groups, and so on.

As non-crosslinking acrylic monomer units, one may cite, for example, ester (meth)acrylate units in which hydrogen atoms of carboxy groups of (meth)acrylic acid are substituted with hydrocarbon groups. The carbon number of the pertinent hydrocarbon groups is preferably 1-18, and more preferably 1-8. The pertinent hydrocarbon groups may have substituents. There are no particular limitations on the pertinent substituents provided that they do not include crosslinking groups, and one may cite, for example, alkoxy groups such as methoxy groups and ethoxy groups.

As the pertinent ester (meth)acrylate, one may specifically cite methyl(meth)acrylate, ethyl(meth)acrylate, propyl(meth)acrylate, isopropyl(meth)acrylate, n-butyl(meth)acrylate, isobutyl(meth)acrylate, t-butyl(meth)acrylate, n-pentyl(meth)acrylate, n-hexyl(meth)acrylate, 2-ethylhexyl(meth)acrylate, n-octyl(meth)acrylate, isooctyl(meth)acrylate, n-nonyl(meth)acrylate, isononyl(meth)acrylate, n-decyl(meth)acrylate, isodecyl(meth)acrylate, n-undecyl(meth)acrylate, n-dodecyl(meth)acrylate, stearic(meth)acrylate, methoxyethyl(meth)acrylate, ethoxyethyl(meth)acrylate, cyclohexyl(meth)acrylate, and benzyl(meth)acrylate. These may be used alone, or in combinations of two or more.

In the present invention, “(meth)acrylic acid” signifies that both “acrylic acid” and “methacrylic acid” are included.

Among these, n-butyl acrylate, 2-ethylhexyl acrylate, and methyl acrylate are preferable from the standpoint of adhesion.

As crosslinking monomer units, one may cite copolymer monomer units including carboxy groups, copolymer monomer units including hydroxy groups, copolymer monomer units including amino groups, and copolymer monomer units including glycidyl groups. As copolymer monomer units including carboxy groups, one may cite, for example, α,β-unsaturated carboxylic acid and its anhydrides such as acrylic acid, methacrylic acid, crotonic acid, maleic acid, fumaric acid, itaconic acid, citraconic acid, and glataconic acid.

As copolymer monomers including hydroxy groups, one may cite, for example, hydroxyalkyl (meth)acrylates such as 2-hydroxyethyl (meth)acrylate, 4-hydroxybutyl (meth)acrylate, and 2-hydroxy propyl (meth)acrylate; (meth)acrylic acid [(mono-, di-, or poly-) alkylene glycol] such as mono(diethylene glycol) (meth)acrylate, and lactone (meth)acrylates such as monocaprolactone (meth)acrylate.

As copolymer monomers including amino groups, one may cite, for example, (meth)acrylamide and acrylamide.

As copolymer monomers including glycidyl groups, one may say, for example, glycidyl (meth)acrylate.

Among these, from the standpoint of adhesiveness, crosslinking and polymerization properties, and also small corrosivity of metals such as tin-doped indium oxide used in transparent conducting film and copper used in electromagnetic shielding material, copolymer monomers including hydroxy groups are preferable, hydroxyalkyl (meth)acrylate is more preferable, and 2-hydroxyethyl (meth)acrylate and 4-hydroxybutyl (meth)acrylate are particularly preferable.

In the case where copolymer monomer units including carboxy groups are included as crosslinking monomer units, due to their strong acidity, when there is contact with film having corrosivity such as tin-doped indium oxide film or metallic film, these films may experience corrosion. Consequently, from the standpoint of corrosion prevention, when including copolymer monomer units including carboxy groups as crosslinking monomer units, their content is preferably less than 0.5 weight %, and their complete absence is more preferable.

The content of cross-linking monomer units in the acrylic polymer is preferably 0.01-20 weight %, and more preferably 0.5-10 weight %. If the content of crosslinking monomer units is at or above the aforementioned lower limit value, crosslinking can be adequately conducted, and swelling prevention and punching performance can be further enhanced, and if at or below the aforementioned upper limit value, adequate adhesiveness, the conformance to irregularities, and curling prevention performance can be assured.

In the case where copolymer monomer units including carboxy groups are included as crosslinking monomer units, when there is contact with film having corrosivity such as tin-doped indium oxide film or metallic film, these films may experience corrosion due to their strong acidity. Consequently, in FIG. 1, in the case where the pertinent double-faced sheet 110 is used in applications where there is contact with film having corrosivity, and where the acrylic polymer used in the second pressure-sensitive adhesive layer 112 contains copolymer monomers including carboxy groups as crosslinking monomer units, from the standpoint of corrosion prevention, the content of copolymer monomers including carboxy groups in the pertinent acrylic polymer is preferably less than 0.5 weight %, and their complete absence is more preferable. With respect to the entire double-faced pressure-sensitive adhesive sheet 110, from the standpoint of corrosion prevention, the content of copolymer monomer units including carboxy groups in the pertinent acrylic polymer is preferably less than 1.0 weight %. In FIG. 4, in the case where the pertinent double-faced pressure-sensitive adhesive sheet 210 is used in applications where there is contact with film having corrosivity, and where the acrylic polymer used in the second pressure-sensitive adhesive layer 212 or the third pressure-sensitive adhesive layer 213 contains copolymer monomers including carboxy groups as crosslinking monomer units, from the standpoint of corrosion prevention, the content of copolymer monomer units including carboxy groups in the pertinent acrylic polymer is preferably less than 0.5 weight %, and their complete absence is more preferable. With respect to the entire double-faced pressure-sensitive adhesive sheet 210, from the standpoint of corrosion prevention, the content of copolymer monomer units including carboxy groups in the pertinent acrylic polymer is preferably less than 1.0 weight %.

The acrylic polymer may have other monomer units apart from non-crosslinking acrylic monomer units and cros slinking monomer units. As other monomers, one may cite (meta)acrylonitrile, vinyl acetate, styrene, vinyl chloride, vinyl pyrrolidone, and vinyl pyridine.

The content of other monomer units in the acrylic polymer is preferably 0.1-20 weight %, and more preferably 0.5-10 weight %. If the content of other monomer units is at or above the aforementioned lower limit value, physical properties can be easily adjusted, and if at or below the aforementioned upper limit value, yellowing and the like due to deterioration over time can be prevented.

Crosslinking Agent

As the crosslinking agent, one may cite, for example, isocyanate compounds, epoxy compounds, oxazoline compounds, aziridine compounds, metal chelate compounds, butylated melamine compounds, and so on. Among these crosslinking agents, isocyanate compounds and epoxy compounds are preferable, because they facilitate crosslinking of acrylic polymers. Particularly in the case where the acrylic polymer contains only copolymer monomer units including hydroxy groups as the crosslinking monomer units, it is preferable to use isocyanate compounds due to their reactivity with hydroxy groups.

As isocyanate compounds, one may cite, for example, tolylene diisocyanate, xylylene diisocyanate, hexamethylene diisocyanate, isophorone diisocyanate, and so on. As epoxy compounds, one may cite, for example, ethylene glycol diglycidyl ether, polyethylene glycol diglycidyl ether, propylene glycol diglycidyl ether, polypropylene glycol diglycidyl ether, glycerine diglycidyl ether, neopentylglycol diglycidyl ether, 1,6-hexanediol diglycidyl ether, tetraglycidylxylene diamine, 1,3-bis(N,N-diglycidylaminomethyl)cyclohexane, trimethylolpropane polyglycidyl ether, diglycerol polyglycidyl ether, polyglycerol polyglycidyl ether, sorbitol polyglycidyl ether, and so on. It is preferable that the content of the crosslinking agent(s) be suitably selected according to the desired adhesive properties.

Molecular Weight

Weight average molecular weight of the two-part acrylic pressure-sensitive adhesive (I) in the first pressure-sensitive adhesive layer 111 or 211 is 150,000 to 800,000, 350,000 to 800,000 is preferable, and 400,000 to 700,000 is more preferable. When weight average molecular weight of the two-part acrylic pressure-sensitive adhesive (I) is less than the aforementioned lower limit value, it may happen that sufficient cohesive strength is not demonstrated, and that durability is poor, and when the aforementioned upper limit value is exceeded, curling prevention performance and the conformance to irregularities are adversely affected.

The dispersivity (weight average molecular weight/number average molecular weight) of the two-part acrylic pressure-sensitive adhesive (I) is preferably 10 or less, and more preferably 6 or less.

If dispersivity of the two-part acrylic pressure-sensitive adhesive (I) is at or below the aforementioned upper limit value, low molecular components less than 100,000 in molecular weight are reduced, cohesive strength is raised, and durability is enhanced.

The weight average molecular weight and dispersivity of the two-part acrylic pressure-sensitive adhesive (I) of the present invention are respectively the weight average molecular weight and dispersivity of the acrylic polymer prior to crosslinkage by the crosslinking agent. The pertinent weight average molecular weight and dispersivity are values measured by gel permeation chromatography, and obtained with a polystyrene standard. The same applies to the weight average molecular weight and dispersivity of the below-mentioned two-part acrylic pressure-sensitive adhesive (II).

Additives

Antioxidants, metal corrosion inhibitors, tackifiers, silane coupling agents, light stabilizers such as ultraviolet absorbers and hindered amine compounds, fillers, and other additives may be included as necessary in the first double-faced pressure-sensitive adhesive layer 111 or 211.

As antioxidants, one may cite phenol antioxidants, amine antioxidants, lactone antioxidants, phosphoric antioxidants, sulfuric antioxidants, and so on. These antioxidants may be used alone, or in combinations of two or more

As metal corrosion inhibitors, benzotriazole resin is preferable from the standpoint of enhancing adhesive compatibility and effects.

As tackifiers, one may cite, for example, rosin resin, terpene resin, terpene-phenol resin, coumarone-indene resin, styrene resin, xylene resin, phenol resin, oil resin, and so on.

As silane coupling agents, one may cite, for example, mercaptoalkoxy silane compounds (e.g., alkoxy oligomer with mercapto substituents), and so on.

As ultraviolet absorbers, one may cite, for example, benzotriazole compounds, benzophenone compounds, and so on. In particular, given that ultraviolet absorbers may cause adherend contamination and degradation of adhesive force due to “bleed out,” ultraviolet absorbers are preferably added to the first pressure-sensitive adhesive layer 111 or 211 if they are to be added.

The blending proportion of these additives varies according to the first pressure-sensitive adhesive layer to be employed. Ordinarily, relative to 100 weight parts of a first pressure-sensitive adhesive layer, 0.01-10 weight parts is preferable, 0.05-5 weight parts is more preferable, and 0.1-3 weight parts is particularly preferable.

With respect to additives, it is also possible to impart antistatic performance to the adhesive by using ionic liquids such as nitrogen-containing onium salt, sulfur-containing onium salt, or phosphorous-containing onium salt, and preferably ionic salts selected from a group composed of the following formulas (A), (B), (C), and (D). Ionic salt exhibits a liquid or solid form at 25° C.

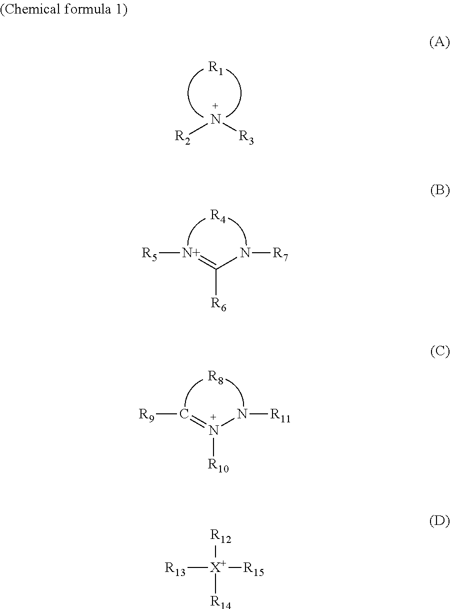

[In formula (A), R₁ indicates a hydrocarbon group with a carbon number from 4 to 20, and may include hetero atoms; R₂ and R₃ may be identical or different, indicate a hydrocarbon group with a hydrogen or carbon number from 1 to 16, and may include hetero atoms. However, when nitrogen atoms include double bonds, there is no R₃. In formula (B), R₄ indicates a hydrocarbon group with a carbon number from 2 to 20, and may include hetero atoms; R₅, R₆ and R₇ may be identical or different, indicate a hydrocarbon group with a hydrogen or carbon number from 1 to 16, and may include hetero atoms.

In formula (C), R₈ indicates a hydrocarbon group with a carbon number from 2 to 20, and may include hetero atoms; R₉, R₁₀ and R₁₁ may be identical or different, indicate a hydrocarbon group with a hydrogen or carbon number from 1 to 16, and may include hetero atoms. In formula (D), X indicates nitrogen, sulfur, or phosphorous atoms; R₁₂, R₁₃, R₁₄, and R₁₅ may be identical or different, indicate a hydrocarbon group with a carbon number from 1 to 20, and may include hetero atoms. However, when X indicates sulfur atoms, there is no R₁₂.

As cations expressed by Formula (A), one may cite pyridinium cation, piperidinium cation, pyrrolidinium cation, cations having a pyrroline skeleton, cations having a pyrrol skeleton, and so on. Specifically, one may cite 1-ethylpyridinium cation, 1-butylpyridinium cation, 1-hexylpyridinium cation, 1-butyl-3 methylpyridinium cation, 1-butyl-4-methylpyridinium cation, 1-hexyl-3-methylpyridinium cation, 1-butyl-3,4-dimethylpyridinium cation, 1,1-dimethylpyrrolidinium cation, 1-ethyl-1-methylpyrrolidinium cation, 1-methyl-1-propylpyrrolidinium cation, 2-methyl-1-pyrroline cation, 1-ethyl-2-phenylindole cation, 1,2-dimethylindole cation, and 1-ethylcarbazole cation.

As cations expressed by Formula (B), one may cite imidazolium cation, tetrahydropyrimidinium cation, dihydropyrimidinium cation, and so on. Specifically, one may cite 1,3-dimethylimidazolium cation, 1,3-diethylimidazolium cation, 1-ethyl-3-methylimidazolium cation, 1-butyl-3-methylimidazolium cation, 1-hexyl-3-methylimidazolium cation, 1-octyl-3-methylimidazolium cation, 1-decyl-3-methylimidazolium cation, 1-dodecyl-3-methylimidazolium cation, 1-tetradecyl-3-methylimidazolium cation, 1,2-dimethyl-3-propylimidazolium cation, 1-ethyl-2,3-dimethylimidazolium cation, 1-butyl-2,3-dimethylimidazolium cation, 1-hexyl-2,3-dimethylimidazolium cation, 1,3-dimethyl-1,4,5,6-tetrahydropyrimidinium cation, 1,2,3-trimethyl-1,4,5,6-tetrahydropyrimidinium cation, 1,2,3,4-tetramethyl-1,4,5,6-tetrahydropyrimidinium cation, 1,2,3,5-tetramethyl-1,4,5,6-tetrahydropyrimidinium cation, 1,3-dimethyl-1,4-dihydropyrimidinium cation, 1,3-dimethyl-1,6-dihydropyrimidinium cation, 1,2,3-trimethyl-1,4-dihydropyrimidinium cation, 1,2,3-trimethyl-1,6-dihydropyrimidinium cation, 1,2,3,4-tetramethyl-1,4-dihydropyrimidinium cation, 1,2,3,4-tetramethyl-1,6-dihydropyrimidinium cation, and so on.

As cations expressed by Formula (C), one may cite pyrazolium cation, pyrazolinium cation, and so on. Specifically, one may cite 1-methylpyrazolium cation, 3-methylpyrazolium cation, 1-ethyl-2-methylpyrazolinium cation, and so on.

As cations expressed by Formula (D), one may cite tetraalkylammonium cation, trialkylsulfonium cation, tetraalkylphosphonium cation, cations where a portion of the aforementioned alkyl group is replaced by an alkenyl group, alkoxyl group or even an epoxy group, and so on. Specifically, one may cite, for example, tetramethylammonium cation, tetraethylammonium cation, tetrabutylammonium cation, tetrahexylammonium cation, triethylmethylammonium cation, tributylethylammonium cation, trimethyldecylammonium cation, N,N-diethyl-N-methyl-N-(2-methoxyethyl)ammonium cation, glycidyltrimethylammonium cation, N,N-dimethyl-N,N-dipropylammonium cation, N,N-dimethyl-N,N-dihexylammonium cation, N,N-dipropyl-N,N-dihexylammonium cation, trimethylsulfonium cation, triethylsulfonium cation, tributylsulfonium cation, trihexylsulfonium cation, diethylmethylsulfonium cation, dibutylethylsulfonium cation, dimethyldecylsulfonium cation, tetramethylphosphonium cation, tetraethylphosphonium cation, tetrabutylphosphonium cation, tetrahexylphosphonium cation, triethylmethylphosphonium cation, tributylethylphosphonium cation, trimethyldecylphosphonium cation, diaryldimethylammonium cation, and so on.

On the other hand, with respect to the anionic component, there are no particular limitations provided that the condition of becoming ionic liquid is satisfied, and one may use, for example, Cl⁻, Br⁻, I⁻, AlCl₄⁻, Al₂Cl₇⁻, BF₄⁻, PF₆⁻, ClO₄⁻, NO₃⁻, CH₃COO⁻, SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂)(CF₃CO)N⁻, and so on. Among these, use of anionic components containing fluorine atoms is particularly preferable, due to obtainment of ionic compounds of low melting point.

With respect to the aforementioned ionic salt, commercial products may be used, and can be suitably synthesized. There are no particular limitations on the method of synthesis of the pertinent ionic salt in liquid form, provided that it is a method which obtains the target ionic liquid. For example, one may use the halide method recorded in the document “Ionic Liquids: the Front Line of Development and the Future” (published by CMC Publishing Co., Ltd.), as well as the hydroxide method, acid ester method, complex formation method, neutralization method, and methods conforming thereto or methods combining common procedures therewith.

Thickness

There are no particular limitations on the thickness of the first pressure-sensitive adhesive layer 111, which can be suitably set taking into consideration the desired overall thickness and the like of the double-faced pressure-sensitive adhesive sheet 110, but the thickness of the first pressure-sensitive adhesive layer 111 is preferably 1.5-fold to 100-fold that of the below-mentioned second pressure-sensitive adhesive layer 112. In particular, 2-fold to 20-fold is more preferable in the case where overall thickness of the double-faced pressure-sensitive adhesive sheet 110 (first pressure-sensitive adhesive layer+second pressure-sensitive adhesive layer) is 100 μm or less, and 10-fold to 80-fold is more preferable in the case where overall thickness of the double-faced pressure-sensitive adhesive sheet 110 (first pressure-sensitive adhesive layer+second pressure-sensitive adhesive layer) is above 100 μm. If the thickness of the first pressure-sensitive adhesive layer 111 is at or above the aforementioned lower limit value of the thickness of the second pressure-sensitive adhesive layer 112, the conformance to irregularities is further enhanced when conducting adhesion of the double-faced pressure-sensitive adhesive sheet 110 to an irregular surface, and if at or below the aforementioned upper limit value, the first pressure-sensitive adhesive layer 111 can be easily formed.

Moreover, the thickness of the first pressure-sensitive adhesive layer 111 is preferably 20-500 μm, and more preferably 25-400 μm. If the thickness of the first pressure-sensitive adhesive layer 111 is at or above the aforementioned lower limit value, the conformance to irregularities is further enhanced when conducting adhesion of the double-faced pressure-sensitive adhesive sheet 110 to an irregular surface, and if at or below the aforementioned upper limit value, the first pressure-sensitive adhesive layer 111 can be easily formed.

There are no particular limitations on the thickness of the first pressure-sensitive adhesive layer 211, which can be suitably set taking into consideration the desired overall thickness and the like of the double-faced pressure-sensitive adhesive sheet 210, but it is preferably 1.5-fold to 100-fold that of the below-mentioned second pressure-sensitive adhesive layer 212. In particular, 2-fold to 20-fold is more preferable in the case where overall thickness of the double-faced pressure-sensitive adhesive sheet 210 (first pressure-sensitive adhesive layer+second pressure-sensitive adhesive layer+third pressure-sensitive adhesive layer) is 100 μm or less, and 10-fold to 80-fold is more preferable in the case where overall thickness of the double-faced pressure-sensitive adhesive sheet 210 (first pressure-sensitive adhesive layer+second pressure-sensitive adhesive layer+third pressure-sensitive adhesive layer) is above 100 μm. If the thickness of the first pressure-sensitive adhesive layer 211 is at or above the aforementioned lower limit value of the thickness of the second pressure-sensitive adhesive layer 212, the conformance to irregularities is further enhanced when conducting adhesion of the double-faced pressure-sensitive adhesive sheet 210 to an irregular surface, and if at or below the aforementioned upper limit value, the first pressure-sensitive adhesive layer 211 can be easily formed.

Moreover, the thickness of the first pressure-sensitive adhesive layer 211 is preferably 20-500 μm, and more preferably 25-400 μm. If the thickness of the first pressure-sensitive adhesive layer 211 is at or above the aforementioned lower limit value, the conformance to irregularities is further enhanced when conducting adhesion of the double-faced pressure-sensitive adhesive sheet 210 to an irregular surface, and if at or below the aforementioned upper limit value, the first pressure-sensitive adhesive layer 211 can be easily formed.

Elastic Modulus of the Pressure-Sensitive Adhesive

The storage elastic modulus (hereinafter “G′”) of the first pressure-sensitive adhesive layer 111 or 211 at a frequency of 1 Hz and at 25° C. is preferably 5.0×10⁴ Pa to 8.0×10⁵ Pa. G′ indicates the elastic properties of the pressure-sensitive adhesive layer, and the conformance to irregularities is excellent when G′ at the aforementioned temperature is at or below the aforementioned upper limit value of the aforementioned range. The double-faced pressure-sensitive adhesive sheet 110 or 210 is subjected to punching that conforms to the size of the touchscreen, and when G′ of the first pressure-sensitive adhesive layer 112 or 212 is at or above the lower limit value of the aforementioned range, adherence of the adhesive to the cutting blade is inhibited, and punching property is enhanced.

For similar reasons, G′ of the first pressure-sensitive adhesive layer 111 or 211 at a frequency of 1 Hz and at 50° C. is preferably 1.0×10⁴ Pa to 5.0×10⁵ Pa. Moreover, G′ at a frequency of 1 Hz and at 80° C. is preferably 5.0×10³ Pa to 1.0×10⁵ Pa.

For reasons similar to the above, the loss elastic modulus (hereinafter “G″”) of the first pressure-sensitive adhesive layer 111 or 211 at a frequency of 1 Hz and at 25° C. is preferably 5.0×10⁴ Pa to 8.0×10⁵ Pa. Moreover, G″ at a frequency of 1 Hz and at 50° C. is preferably 1.0×10⁴ Pa to 5.0×10⁵ Pa, and G″ at a frequency of 1 Hz and at 80° C. is preferably 5.0×10³ Pa to 1.0×10⁵ Pa.

For reasons similar to the above, the loss sine (hereinafter “tan δ”) of the first pressure-sensitive adhesive layer 111 or 211 at a frequency of 1 Hz and at 25° C. is preferably 0.50 to 1.50. Moreover, tan δ at a frequency of 1 Hz and at 50° C. is preferably 0.20 to 1.00, and tan δ at a frequency of 1 Hz and at 80° C. is preferably 0.20 to 0.80.

G′ and G″ are measured by rheometer under conditions of a frequency of 1 Hz, strain of 0.1%, and a rate of temperature increase of 3° C./minute, and tan δ is obtained as the ratio of G′ and G″ (G″/G′).

The values of G′, G″ and tan δ can be respectively regulated according to the weight average molecular weight, monomer composition, amount of admixture of crosslinking agent (degree of crosslinkage), and so on of the acrylic polymer.

(Second Pressure-Sensitive Adhesive Layer)

The primary component of the second pressure-sensitive adhesive layer 112 or 212 is a two-part acrylic pressure-sensitive adhesive (II).

Here, the proportion of the two-part acrylic pressure-sensitive adhesive (II) relative to the entirety of the second pressure-sensitive adhesive layer 112 or 212 is 50 weight % or more. Furthermore, from the standpoint of ooze, 70 weight % or more is preferable, and 90 weight % or more is more preferable.

With respect to the two-part acrylic pressure-sensitive adhesive (II), apart from the difference in molecular weight, the same materials may be cited as with respect to the two-part acrylic adhesive (I). Adhesives with constituents and constituent proportions identical to those of the two-part acrylic adhesive (I) contained in the first pressure-sensitive adhesive layer 111 or 211, adhesives with identical constituents and different constituent proportions, and adhesives with different constituents may be selected and used as desired according to purpose (adherend).

Additives may be included as necessary in the second pressure-sensitive adhesive layer 112 or 212. As additives, one may cite the same additives cited for possible inclusion in the first pressure-sensitive adhesive layer 111 or 211. Particularly in the case where the adherend of the second pressure-sensitive adhesive layer 112 or 212 is glass or includes metal as an electrode, in order to maximize the effects thereof, a silane coupling agent and a metal corrosion inhibitor are preferably added to the second pressure-sensitive adhesive layer 112 or 212.

Molecular Weight

The weight average molecular weight of the two-part acrylic pressure-sensitive adhesive (II) in the second pressure-sensitive adhesive layer 112 or 212 is 900,000-2,000,000, and preferably 1,000,000-180,000,000. When the weight average molecular weight of the two-part acrylic pressure-sensitive adhesive (II) is less than the aforementioned lower limit value, swelling tends to occur, and when it exceeds the aforementioned upper limit value, problems may arise such as inhibition of the conformance to irregularities, excessive increase in viscosity of the coating color of the pressure-sensitive adhesive, impediments to coating with the pressure-sensitive adhesive, and the like.

The dispersivity (weight average molecular weight/number average molecular weight) of the two-part acrylic pressure-sensitive adhesive (II) is preferably less than 10, and more preferably less than 6. If the dispersivity of the two-part acrylic pressure-sensitive adhesive (II) is at or below the aforementioned upper limit value, there tends to be a reduction in low molecular components, an increase in cohesive strength, further inhibition of swelling, and enhancement of punching workability.

Thickness

The thickness of the second pressure-sensitive adhesive layer 112 is preferably 5-50 μm, and more preferably 10-30 μm. If the thickness of the second pressure-sensitive adhesive layer 112 is at or above the aforementioned lower limit value, swelling can be prevented when conducting adhesion of the second pressure-sensitive adhesive layer 112 to a polycarbonate sheet or a polymethyl methacrylate sheet. If the thickness of the second pressure-sensitive adhesive layer 112 is at or below the aforementioned upper limit value, curling prevention performance and the conformance to irregularities are excellent.

As the weight average molecular weight of the two-part acrylic pressure-sensitive adhesive (II) composing the pressure-sensitive adhesive layer 112 is large, the viscosity of the coating color that serves to form the second pressure-sensitive adhesive layer 112 tends to increase, which may thin the coating color concentration, but if the thickness of the second pressure-sensitive adhesive layer 112 is at or below the aforementioned upper limit value, formation can be easily conducted even if the coating color concentration is thin.

Moreover, the thickness of the second pressure-sensitive adhesive layer 212 is 5-50 μm, and preferably 10-30 μm. If the thickness of the second pressure-sensitive adhesive layer 212 is at or above the aforementioned lower limit value, swelling can be prevented when conducting adhesion of the second pressure-sensitive adhesive layer 212 to a polycarbonate sheet or a polymethyl methacrylate sheet. If the thickness of the second pressure-sensitive adhesive layer 212 is at or below the aforementioned upper limit value, curling prevention performance and the conformance to irregularities are excellent. As the weight average molecular weight of the two-part acrylic pressure-sensitive adhesive (II) composing the second pressure-sensitive adhesive layer 212 is large, the viscosity of the coating color that serves to form the second pressure-sensitive adhesive layer 212 tends to increase, which may thin the coating color concentration, but if the thickness of the second pressure-sensitive adhesive layer 212 is at or below the aforementioned upper limit value, formation can be easily conducted even if the coating color concentration is thin.

Elastic Modulus of Pressure-Sensitive Adhesive

G′ of the second pressure-sensitive adhesive layer 112 or 212 at a frequency of 1 Hz and at 25° C. is preferably 1.0×10⁵ Pa to 5.0×10⁶ Pa. Curling prevention performance and the conformance to irregularities are excellent when G′ at each of the aforementioned temperatures is at or below the upper limit value of the aforementioned range, and punching aptitude is enhanced when it is at or above the lower limit value.

For similar reasons, G′ of the second pressure-sensitive adhesive layer 112 or 212 at a frequency of 1 Hz and at 50° C. is preferably 8.0×10⁴ Pa to 2.0×10⁶ Pa. Moreover, G′ at a frequency of 1 Hz and at 80° C. is preferably 1.0×10⁴ Pa to 1.0×10⁶ Pa.

For reasons similar to the above, G″ of the second pressure-sensitive adhesive layer 112 or 212 at a frequency of 1 Hz and at 25° C. is preferably 7.0×10⁴ Pa to 5.0×10⁶ Pa. Moreover, G″ at a frequency of 1 Hz and at 50° C. is preferably 1.0×10⁴ Pa to 5.0×10⁵ Pa, and G″ at a frequency of 1 Hz and at 80° C. is preferably 1.0×10⁴ Pa to 2.0×10⁵ Pa.

For reasons similar to the above, tan δ of the second pressure-sensitive adhesive layer 112 or 212 at a frequency of 1 Hz and at 25° C. is preferably 0.20 to 1.00. Moreover tan δ at a frequency of 1 Hz and at 50° C. is preferably 0.10 to 0.50, and tan δ at a frequency of 1 Hz and at 80° C. is preferably 0.10 to 0.50.

In the present invention, as the weight average molecular weight of the two-part acrylic adhesive (I) is 150,000-800,000, and as the weight average molecular weight of the two-part acrylic pressure-sensitive adhesive (II) of the second pressure-sensitive adhesive layer is 900,000-2,000,000, G′ of the second pressure-sensitive adhesive layer 112 or 212 tends to be smaller than G′ of the first pressure-sensitive adhesive layer 111 or 211.

(Third Pressure-Sensitive Adhesive Layer)

The primary component of the third pressure-sensitive adhesive layer 213 is a two-part acrylic pressure-sensitive adhesive (III).

Here, the proportion of the two-part acrylic pressure-sensitive adhesive (III) relative to the entirety of the second pressure-sensitive adhesive layer 213 is 50 weight % or more. Furthermore, from the standpoint of ooze, 70 weight % or more is preferable, and 90 weight % or more is more preferable.

As a two-part acrylic pressure-sensitive adhesive (III), one may cite the same examples as for the aforementioned two-part acrylic pressure-sensitive adhesive (II). The two-part acrylic pressure-sensitive adhesive (III) contained in the third pressure-sensitive adhesive layer 213 may be identical to or different from the two-part acrylic pressure-sensitive adhesive (II) contained in the second pressure-sensitive adhesive layer 212. For example, adhesives with constituents and constituent proportions identical to those of the two-part acrylic adhesive (II), adhesives with identical constituents and different constituent proportions, and adhesives with different constituents may be selected and used as desired according to purpose (adherend).

Additives may be included as necessary in the third pressure-sensitive adhesive layer 213. Examples of additives include the same additives cited for possible inclusion in the first pressure-sensitive adhesive layer 211. Particularly in the case where the adherend of the third pressure-sensitive adhesive layer 213 is glass or includes metal such as cupper or silver as an electrode, in order to maximize the effects thereof, a silane coupling agent and a metal corrosion inhibitor are preferably added to the third pressure-sensitive adhesive layer 213.

Molecular Weight

The weight average molecular weight of the two-part acrylic pressure-sensitive adhesive (III) in the second pressure-sensitive adhesive layer 213 is 900,000-2,000,000, and preferably 1,000,000-180,000,000. When the weight average molecular weight of the two-part acrylic pressure-sensitive adhesive (III) is less than the aforementioned lower limit value, swelling tends to occur, and punching aptitude deteriorates, and when it exceeds the aforementioned upper limit value, problems may arise such as inhibition of the conformance to irregularities, excessive increase in viscosity of the coating color of the pressure-sensitive adhesive, impediments to coating with the pressure-sensitive adhesive, and the like.

The dispersivity (weight average molecular weight/number average molecular weight) of the two-part acrylic pressure-sensitive adhesive (III) is preferably less than 10, and more preferably less than 6. If the dispersivity of the two-part acrylic pressure-sensitive adhesive (III) is at or below the aforementioned upper limit value, there tends to be a reduction in low molecular components, an increase in cohesive strength, and further inhibition of swelling.

Thickness

The thickness of the third pressure-sensitive adhesive layer 213 is preferably 5-50 μm, and more preferably 10-30 μm. If the thickness of the third pressure-sensitive adhesive layer 213 is at or above the aforementioned lower limit value, swelling can be prevented when conducting adhesion of the third pressure-sensitive adhesive layer 213 to a polycarbonate sheet or a polymethyl methacrylate sheet. The double-faced pressure-sensitive adhesive sheet 10 [sic] has a certain degree of the conformance to irregularities due to the thickness of the aforementioned second pressure-sensitive adhesive layer 212 being at or below the aforementioned upper limit value, and its conformance to irregularities is further enhanced by having the thickness of the third pressure-sensitive adhesive layer 213 at or below the aforementioned upper limit value. As the weight average molecular weight of the two-part acrylic pressure-sensitive adhesive (III) composing the third pressure-sensitive adhesive layer 213 is large, the viscosity of the coating color that serves to form the third pressure-sensitive adhesive layer 213 tends to increase, which may thin the coating color concentration, but if the thickness of the third pressure-sensitive adhesive layer 213 is at or below the aforementioned upper limit value, formation can be easily conducted even if the coating color concentration is thin.

Elastic Modulus of the Pressure-Sensitive Adhesive

G′ of the third pressure-sensitive adhesive layer 213 at a frequency of 1 Hz and at 25° C. is preferably 1.0×10⁵ Pa to 5.0×10⁶ Pa. The conformance to irregularities is excellent when G′ at each of the aforementioned temperatures is at or below the upper limit value of the aforementioned range, and punching aptitude is enhanced when it is at or above the lower limit value.

For similar reasons, G′ of the third pressure-sensitive adhesive layer 213 at a frequency of 1 Hz and at 50° C. is preferably 8.0×10⁴ Pa to 2.0×10⁶ Pa. Moreover, G′ at a frequency of 1 Hz and at 80° C. is preferably 1.0×10⁴ Pa to 1.0×10⁶ Pa.

For reasons similar to the above, G″ of the third pressure-sensitive adhesive layer 213 at a frequency of 1 Hz and at 25° C. is preferably 7.0×10⁴ Pa to 5.0×10⁶ Pa. Moreover, G″ at a frequency of 1 Hz and at 50° C. is preferably 1.0×10⁴ Pa to 5.0×10⁵ Pa.

Moreover, G″ at a frequency of 1 Hz and at 80° C. is preferably 1.0×10⁴ Pa to 2.0×10⁵ Pa.

For reasons similar to the above, tan δ of the third pressure-sensitive adhesive layer 213 at a frequency of 1 Hz and at 25° C. is preferably 0.20 to 1.00.

Moreover tan δ at a frequency of 1 Hz and at 50° C. is preferably 0.10 to 0.50, and tan δ at a frequency of 1 Hz and at 80° C. is preferably 0.10 to 0.50.

In the present invention, as the weight average molecular weight of the two-part acrylic adhesive (I) is 150,000-800,000, and as the weight average molecular weight of the two-part acrylic pressure-sensitive adhesive (III) of the third pressure-sensitive adhesive layer is 900,000-2,000,000, G′ of the third pressure-sensitive adhesive layer 213 tends to be smaller than G′ of the first pressure-sensitive adhesive layer 211.

G′ at a frequency of 1 Hz and at 25° C. of the entire double-faced pressure-sensitive adhesive sheet 110 (in a state of lamination of the first pressure-sensitive adhesive layer and the second pressure-sensitive adhesive layer) or the entire double-faced pressure-sensitive adhesive sheet 210 (in a state of lamination of the first pressure-sensitive adhesive layer, the second pressure-sensitive adhesive layer and the third pressure-sensitive adhesive layer) is preferably 1×10⁵ Pa to 9×10⁵ Pa, and more preferably 2×10⁵ Pa to 5×10⁵ Pa. The conformance to irregularities is excellent when G′ at each of the aforementioned temperatures is at or below the upper limit value of the aforementioned range, and punching aptitude is enhanced when it is at or above the lower limit value.

For similar reasons, G′ at a frequency of 1 Hz and at 50° C. of the double-faced pressure-sensitive adhesive sheet 110 or 210 is preferably 7×10⁴ Pa to 5×10⁶ Pa, and more preferably 1×10⁵ Pa to 3×10⁵ Pa; and G′ at a frequency of 1 Hz and at 80° C. of the double-faced pressure-sensitive adhesive sheet 110 or 210 is preferably 7×10⁴ Pa to 5×10⁶ Pa.

For reasons similar to the above, G″ at a frequency of 1 Hz and at 25° C. of the double-faced pressure-sensitive adhesive sheet 110 or 210 is preferably 7×10⁴ Pa to 5×10⁶ Pa, and more preferably 1×10⁵ Pa to 3×10⁵ Pa. G″ at a frequency of 1 Hz and at 50° C. is preferably 5×10⁴ Pa to 5×10⁵ Pa, and more preferably 7×10⁴ Pa to 2×10⁵ Pa. G″ at a frequency of 1 Hz and at 80° C. is preferably 1×10⁴ Pa to 9×10⁵ Pa, and more preferably 3×10⁴ Pa to 5×10⁴ Pa.

For reasons similar to the above, tan δ at a frequency of 1 Hz and at 25° C. of the double-faced pressure-sensitive adhesive sheet 110 or 210 is preferably 0.2 to 1.0, and more preferably 0.5 to 0.8; tan δ at a frequency of 1 Hz and at 50° C. is preferably 0.2 to 1.0, and more preferably 0.3 to 0.6; and tan δ at a frequency of 1 Hz and at 80° C. is preferably 0.1 to 0.8, and more preferably 0.2 to 0.5.

(Operational Effects)

In the aforementioned double-faced pressure-sensitive adhesive sheet 110, the pressure-sensitive adhesive layers are laminated in two layers which are the first pressure-sensitive adhesive layer 111 and the second pressure-sensitive adhesive layer 112, and the average molecular weight of the pressure-sensitive adhesive constituting the primary component of the first pressure-sensitive adhesive layer 111 among these is reduced to weaken cohesive strength. Consequently, the double-faced pressure-sensitive adhesive sheet 110 easily conforms to irregularities not only in the case where the first pressure-sensitive adhesive layer 111 contacts an irregular surface, but also in the case where the second pressure-sensitive adhesive layer 112 contacts an irregular surface.

On the other hand, the weight average molecular weight of the pressure-sensitive adhesive constituting the primary component of the second pressure-sensitive adhesive layer 112 is increased to raise cohesive strength. Even when a gas-generating substrate that generates gas or a moisture-releasing substrate that releases moisture during heating is bonded onto this second pressure-sensitive adhesive layer 112, gas does not collect between the second pressure-sensitive adhesive layer 112 and the gas-generating substrate or the moisture-releasing substrate, enabling prevention of swelling. It is thought that this is because deformation is inhibited when the cohesive strength of the pressure-sensitive adhesive is raised.

In the aforementioned double-faced pressure-sensitive adhesive sheet 210, the pressure-sensitive adhesive layers are laminated in three layers which are the first pressure-sensitive adhesive layer 211, the second pressure-sensitive adhesive layer 212, and the third pressure-sensitive adhesive layer 213. The average molecular weight of the pressure-sensitive adhesive constituting the primary component of the first pressure-sensitive adhesive layer 211 interposed among these is reduced to weaken cohesive strength. Of the second pressure-sensitive adhesive layer 212 and third pressure-sensitive adhesive layer 213 disposed on the outer side thereof, the thickness of at least the second pressure-sensitive adhesive layer 212 is thinned to 50 μm or less. Consequently, the double-faced pressure-sensitive adhesive sheet 210 easily conforms to irregularities not only in the case where the second pressure-sensitive adhesive layer 212 contacts an irregular surface, but also in the case where the third pressure-sensitive adhesive layer 213 contacts an irregular surface.

On the other hand, the average molecular weights of the pressure-sensitive adhesives constituting the primary components of the second pressure-sensitive adhesive layer 212 and the third pressure-sensitive adhesive layer 213 are increased to raise cohesive strength. Even when a gas-generating substrate that generates gas or a moisture-releasing substrate that releases moisture during heating is bonded onto one or both of this second pressure-sensitive adhesive layer 212 and third pressure-sensitive adhesive layer 213, gas does not collect between the second pressure-sensitive adhesive layer 212 or the third pressure-sensitive adhesive layer 213 and the gas-generating substrate or the moisture-releasing substrate, enabling prevention of swelling. It is thought that this is because deformation is inhibited when the cohesive strength of the pressure-sensitive adhesive is raised.

Double-Faced Pressure-Sensitive Adhesive Sheet with Release Sheet

Prior to use, the aforementioned double-faced pressure-sensitive adhesive sheet 110 is in the state of a double-faced pressure-sensitive adhesive sheet with release sheet where a release sheet is laminated onto at least one surface, and preferably both surfaces, so that the first pressure-sensitive adhesive layer 111 and the second pressure-sensitive adhesive layer 112 are not exposed.

FIG. 2 shows an embodiment of a double-faced pressure-sensitive adhesive sheet with release sheet where a release sheet is laminated onto the double-faced pressure-sensitive adhesive sheet 110. A double-faced pressure-sensitive adhesive sheet with release sheet 120 of the present embodiment is provided with the double-faced pressure-sensitive adhesive sheet 110, a first release sheet 130a laminated onto the surface of the first pressure-sensitive adhesive layer 111 that is opposite the second pressure-sensitive adhesive layer 112, and a second release sheet 130b laminated onto the surface of the second pressure-sensitive adhesive layer 112 that is opposite the first pressure-sensitive adhesive layer 111.

In addition, prior to use, the aforementioned double-faced pressure-sensitive adhesive sheet 210 is in the state of a double-faced pressure-sensitive adhesive sheet with release sheet where a release sheet is laminated onto at least one surface, and preferably both surfaces, so that the second pressure-sensitive adhesive layer 212 and the third pressure-sensitive adhesive layer 213 are not exposed.

FIG. 5 shows an embodiment of a double-faced pressure-sensitive adhesive sheet with release sheet where a release sheet is laminated onto the double-faced pressure-sensitive adhesive sheet 210. A double-faced pressure-sensitive adhesive sheet with release sheet 220 of the present embodiment is provided with the double-faced pressure-sensitive adhesive sheet 210, a first release sheet 230a laminated onto the surface of the double-faced pressure-sensitive adhesive sheet 210 on the second pressure-sensitive adhesive layer 212 side, and a second release sheet 230b laminated onto the surface of the double-faced pressure-sensitive adhesive sheet 210 on the third pressure-sensitive adhesive layer 213 side.

(First Release Sheet and Second Release Sheet)

The first release sheet 130a or 230a and the second release sheet 130b or 230b are sheets with releaseability on at least one side.

As the first release sheet 130a or 230a and as the second release sheet 130b or 230b, one may cite polyolefin film such as polyethylene film or polypropylene film as a low polarity substrate, or a releasable laminate sheet having a release sheet substrate and a release agent layer provided on one side of the pertinent release sheet substrate.

As the release sheet substrate of the releasable laminate sheet, paper or high molecular film is used. As the release agent composing the release agent layer, one may use, for example, general-purpose added or condensed silicone release agents, or compounds containing long-chain alkyl groups. Use of added silicone release agents with high reactivity is particularly preferable.

As silicone release agents, one may specifically cite BY24-4527, SD-7220 and the like manufactured by Dow Corning Toray Silicone Co., and KS-3600, KS-774, X62-2600 and the like manufactured by Shin-Etsu Chemical Co., Ltd. Moreover, the silicone release agent preferably includes a silicone resin which is an organic silicone compound having SiO₂ units and (CH₃)₃SiO_{1/2} units or CH₂═CH(CH₃)SiO_{1/2} units. As specific examples of silicone resin, one may cite BY24-843, SD-7292, SHR-1404 and the like manufactured by Dow Corning Toray Silicone Co., and KS-3800, X92-183 and the like manufactured by Shin-Etsu Chemical Co., Ltd.

It is preferable that the first release sheet 130a and the second release sheet 130b have different degrees of releaseability in order to facilitate release. In short, when the releaseability of the first release sheet 130a from the first pressure-sensitive adhesive layer 111 and the releaseability of the second release sheet 130b from the second pressure-sensitive adhesive layer 112 are different, it is easy to first release only the release sheet with the higher releaseability. In such cases, the releaseability of the first release sheet 130a and the releaseability of the second release sheet 130b may be adjusted according to the adhesion method or adhesion procedure.

When a double-faced pressure-sensitive adhesive sheet is used to conduct adhesion of a substrate that does not generate gas such as polyethylene terephthalate or glass, and a gas generating substrate that generates gas during heating such as polycarbonate or polymethyl methacrylate or a moisture releasing substrate that releases moisture such as triacetyl cellulose, in the case where the double-faced pressure-sensitive adhesive sheet 110 is first bonded to the gas generating substrate or moisture releasing substrate after which it is bonded to the substrate that does not generate gas, the releaseability of the first release sheet 130a is preferably lower than the releaseability of the second release sheet 130b.

Conversely, in the case where bonding to the substrate that does not generate gas occurs first, followed by bonding to the gas generating substrate or moisture releasing substrate, the releaseability of the first release sheet 130a is preferably higher than the releaseability of the second release sheet 130b.

Ordinarily, as it is frequently the case that bonding to the gas generating substrate or moisture releasing substrate occurs first, it is often preferable to set the releaseability of the first release sheet 130a lower than the releaseability of the second release sheet 130b. Releaseability is adjusted according to the type of release agent.

It is preferable that the first release sheet 230a and the second release sheet 230b have different degrees of releaseability in order to facilitate release. In short, when the releaseability of the first release sheet 230a from the first pressure-sensitive adhesive layer 212 and the releaseability of the second release sheet 230b from the second pressure-sensitive adhesive layer 213 are different, it is easy to first release only the release sheet with the higher releaseability. In such cases, the releaseability of the first release sheet 230a and the releaseability of the second release sheet 230b may be adjusted according to the adhesion method or adhesion procedure. Releaseability is adjusted according to the type of release agent.

For example, when the double-faced pressure-sensitive adhesive sheet 210 is used to conduct bonding of a substrate of relatively easy deformation (e.g., a polyethylene terephthalate sheet) and a substrate inhibiting deformation (e.g., glass, or an optical member such as a touchscreen module wherein the optical member is highly rigid and has several layers of lamination), in the case where the third pressure-sensitive adhesive layer 213 of the double-faced pressure-sensitive adhesive sheet 210 is first bonded to the substrate that facilitates deformation followed by bonding of the second pressure-sensitive adhesive layer 212 to the substrate inhibiting deformation, the releaseability of the first release sheet 230a is preferably lower than the releaseability of the second release sheet 230b.

Conversely, in the case where the third pressure-sensitive adhesive layer 213 of the double-faced pressure-sensitive adhesive sheet 210 is first bonded to the substrate of relatively difficult deformation (e.g., glass, or an optical member such as a touchscreen module wherein the optical material is highly rigid and has several layers of lamination) followed by bonding of the second pressure-sensitive adhesive layer 212 to the substrate that facilitates deformation (e.g., a polyethylene terephthalate sheet), the releaseability of the first release sheet 230a is preferably higher than the releaseability of the second release sheet 230b.

Ordinarily, as it is frequently the case that bonding to the substrate of relatively easy deformation such as a polyethylene terephthalate sheet occurs first, it is often preferable to set the releaseability of the first release sheet 230a lower than the releaseability of the second release sheet 230b.

Method of Manufacture of Double-Faced Pressure-Sensitive Adhesive Sheet with a Release Sheet

As a method of manufacture of the aforementioned double-faced pressure-sensitive adhesive sheet with release sheet, one may cite, for example, the following manufacturing methods (1), (2), and the like. Manufacturing method (2) is particularly preferable in the present invention, because it enables manufacture with a small number of processes.

Manufacturing method (1) includes: a step in which coating color to form a first pressure-sensitive adhesive layer containing a crosslinking agent and an acrylic polymer with a weight average molecular weight of 150,000-800,000 is coated onto a release sheet, and heating is conducted to form a first pressure-sensitive adhesive layer, and to obtain a first pressure-sensitive adhesive sheet; a step in which coating color to form a second pressure-sensitive adhesive layer containing a crosslinking agent and an acrylic polymer with a weight average molecular weight of 900,000-2,000,000 is coated onto another release sheet, and heating is conducted to form a second pressure-sensitive adhesive layer, and to obtain a second pressure-sensitive adhesive sheet; and a step in which the aforementioned first pressure-sensitive adhesive sheet in the aforementioned second pressure-sensitive adhesive sheet are superimposed so that the aforementioned first pressure-sensitive adhesive layer and the aforementioned second pressure-sensitive adhesive layer are in contact, and pressure bonding is conducted to obtain a double-faced pressure-sensitive adhesive sheet with release sheet.

Manufacturing method (2) has a step in which coating color to form a first pressure-sensitive adhesive layer containing a crosslinking agent and an acrylic polymer with a weight average molecular weight of 150,000-800,000 and coating color to form a second pressure-sensitive adhesive layer containing a crosslinking agent and an acrylic polymer with a weight average molecular weight of 900,000-2,000,000 are simultaneously multilayer coated onto a release sheet, and heating is conducted to form the aforementioned double-faced pressure-sensitive adhesive sheet.

Manufacturing method (2) may also have a step in which a release sheet different from the release sheet onto which coating color to form a first pressure-sensitive adhesive layer and coating color to form a second pressure-sensitive adhesive layer are simultaneously multilayer coated is laminated onto the formed double-faced pressure-sensitive adhesive sheet.

Manufacturing method (1) will now be described in detail as exemplified by the case of manufacture of the aforementioned double-faced pressure-sensitive adhesive sheet with release sheet 120 shown in FIG. 2. The aforementioned double-faced pressure-sensitive adhesive sheet with release sheet 120 is manufactured, for example, by the following manufacturing method.

First, coating color to form a first pressure-sensitive adhesive layer containing an acrylic polymer, a crosslinking agent, and a solvent is coated onto a surface with releaseability of the first release sheet 130a. Here, the coating method of the color to form the first pressure-sensitive adhesive layer may be suitably selected from among a knife coater, micro bar coater, air knife coater, reverse roll coater, reverse gravure coater, variogravure coater, die coater, curtain coater, and so on.

Next, the coated coating color to form the first pressure-sensitive adhesive layer is heated with the result that the solvent of coating color to form the pressure-sensitive adhesive layer evaporates, the acrylic polymer and the crosslinking agent react, the first pressure-sensitive adhesive layer 111 is formed, and a first pressure-sensitive adhesive sheet A is obtained.

In addition, coating color to form a second pressure-sensitive adhesive layer containing an acrylic polymer, a crosslinking agent, and a solvent is coated onto a surface with releaseability of the second release sheet 130b. Here, with respect to the coating method of the s coating color to form the second pressure-sensitive adhesive layer, a method identical to the coating method of coating color to form the first pressure-sensitive adhesive layer may be applied.

Next, the coated coating color to form the second pressure-sensitive adhesive layer is heated, with the result that the solvent of coating color to form the pressure-sensitive adhesive layer evaporates, the acrylic polymer and the crosslinking agent react, the second pressure-sensitive adhesive layer 112 is formed, and a second pressure-sensitive adhesive sheet B is obtained.

Next, the first pressure-sensitive adhesive sheet A and the second pressure-sensitive adhesive sheet B are superimposed so that the first pressure-sensitive adhesive layer 111 and the second pressure-sensitive adhesive layer 112 are in contact, and pressure bonding is conducted to obtain the double-faced pressure-sensitive adhesive sheet with release sheet 120.

Manufacturing method (2) will now be described in detail as exemplified by the case of manufacture of the aforementioned double-faced pressure-sensitive adhesive sheet with release sheet 120. The aforementioned double-faced pressure-sensitive adhesive sheet with release sheet 120 is manufactured, for example, by the following manufacturing method.

First, coating color to form a first pressure-sensitive adhesive layer containing an acrylic polymer, a crosslinking agent, and a solvent and coating color to form a second pressure-sensitive adhesive layer containing an acrylic polymer, a crosslinking agent, and a solvent are simultaneously multilayer coated onto a surface with releaseability of the first release sheet 130a. Here, as the method for conducting simultaneous multilayer coating of coating color to form the first pressure-sensitive adhesive layer and coating color to form the second pressure-sensitive adhesive layer, one may cite the die coating method, slide beat coating method, curtain coating method, and so on. Among these, the dye coating method is preferable, because there is little risk of clogging and the like due to drying of the coating color, and because formation of a comparatively thick layer is easy compared to other coating methods. Coating by the respective coating methods can be carried out using known coating devices.

Next, the coated coating color to form the first pressure-sensitive adhesive layer and coating color to form the second pressure-sensitive adhesive layer are heated, with the result that the solvents of coating colors to form the respective pressure-sensitive adhesive layers evaporate, and the acrylic polymers and the crosslinking agents react to form the first pressure-sensitive adhesive layer 111 and the second pressure-sensitive adhesive layer 112. By this means, the first release sheet 130a is laminated onto the first pressure-sensitive adhesive layer 111 of the double-faced pressure-sensitive adhesive sheet 120, and a laminate C is obtained.

Next, the second release sheet 130b is laminated onto the second pressure-sensitive adhesive layer 112 of the laminate C to obtain the double-faced pressure-sensitive adhesive sheet with release sheet 120.

In this instance, there was illustration of an example where coating color to form a first pressure-sensitive adhesive layer and coating color to form a second pressure-sensitive adhesive layer are simultaneously multilayer coated onto a first release sheet 130a to form a laminate C, but it is also acceptable to simultaneously conduct multilayer coating of coating color to form the second pressure-sensitive adhesive layer and coating color to form the first pressure-sensitive adhesive layer onto the second release sheet 130b, and to laminate the second release sheet 130b onto the second pressure-sensitive adhesive layer 112 of the double-faced pressure-sensitive adhesive sheet 122 to form the laminate, after which the first release sheet 130a is laminated onto the first pressure-sensitive adhesive layer 111.

As other manufacturing methods for the aforementioned double-faced pressure-sensitive adhesive sheet with release sheet, one may cite, for example, the following manufacturing methods (3) and (4). Manufacturing method (4) is particularly preferable in the present invention, because it enables manufacture with a small number of processes.

Manufacturing method (3) includes: a step in which coating color to form a first pressure-sensitive adhesive layer containing a crosslinking agent and an acrylic polymer with a weight average molecular weight of 150,000-800,000 is coated onto a release sheet, and heating is conducted to form a first pressure-sensitive adhesive layer, and to obtain a first pressure-sensitive adhesive sheet; a step in which coating color to form a second pressure-sensitive adhesive layer containing a crosslinking agent and an acrylic polymer with a weight average molecular weight of 900,000-2,000,000 is coated onto another release sheet, and heating is conducted to form a second pressure-sensitive adhesive layer, and to obtain a second pressure-sensitive adhesive sheet; a step in which coating color to form a third pressure-sensitive adhesive layer containing a crosslinking agent and an acrylic polymer with a weight average molecular weight of 900,000-2,000,000 is coated onto another release sheet, and heating is conducted to form a third pressure-sensitive adhesive layer, and to obtain a third pressure-sensitive adhesive sheet; and a step in which the first pressure-sensitive adhesive layer and the second pressure-sensitive adhesive layer are laminated and pressure bonded, and the first pressure-sensitive adhesive layer and the third pressure-sensitive adhesive layer are laminated and pressure bonded.

Manufacturing method (4) has a step in which coating color to form a first pressure-sensitive adhesive layer containing a crosslinking agent and an acrylic polymer with a weight of average molecular weight of 150,000-800,000, coating color to form a second pressure-sensitive adhesive layer containing a crosslinking agent and an acrylic polymer with a weight average molecular weight of 900,000-2,000,000, and coating color to form a third pressure-sensitive adhesive layer containing a crosslinking agent and an acrylic polymer with a weight average molecular weight of 900,000-2,000,000 are simultaneously multilayer coated onto a release sheet, and heating is conducted to form the aforementioned double-faced pressure-sensitive adhesive sheet.

Manufacturing method (4) may also have a step in which a release sheet different from the release sheet onto which coating color to form the aforementioned first pressure-sensitive adhesive layer, coating color to form the second pressure-sensitive adhesive layer, and coating color to form the third pressure-sensitive adhesive layer are simultaneously multilayer coated is laminated onto the formed double-faced pressure-sensitive adhesive sheet.

Manufacturing method (3) will now be described in detail as exemplified by the case of manufacture of the aforementioned double-faced pressure-sensitive adhesive sheet with release sheet 220 shown in FIG. 5. The aforementioned double-faced pressure-sensitive adhesive sheet with release sheet 220 is manufactured, for example, by the following manufacturing method.

First, coating color to form a first pressure-sensitive adhesive layer containing an acrylic polymer, a crosslinking agent, and a solvent is coated onto a surface with releaseability of the second release sheet 230a. Here, the coating method of coating color to form the second pressure-sensitive adhesive layer may be suitably selected from among a knife coater, micro bar coater, air knife coater, reverse roll coater, reverse gravure coater, variogravure coater, die coater, curtain coater, and so on.

Next, the coated coating color to form the second pressure-sensitive adhesive layer is heated with the result that the solvent of coating color to form the pressure-sensitive adhesive layer evaporates, the acrylic polymer and the crosslinking agent react, the second pressure-sensitive adhesive layer 212 is formed, and a first pressure-sensitive adhesive sheet is obtained.

In addition, coating color to form a third pressure-sensitive adhesive layer containing an acrylic polymer, a crosslinking agent, and a solvent is coated onto a surface with releaseability of the second release sheet 230b. Here, with respect to the coating method of coating color to form the third pressure-sensitive adhesive layer, a method identical to the coating method of coating color to form the second pressure-sensitive adhesive layer may be applied.

Next, the coated coating color to form the third pressure-sensitive adhesive layer is heated, with the result that the solvent of coating color to form the pressure-sensitive adhesive layer evaporates, the acrylic polymer and the crosslinking agent react, the third pressure-sensitive adhesive layer 213 is formed, and a second pressure-sensitive adhesive sheet is obtained.

In addition, another release sheet (third release sheet) is prepared, and coating color to form a first pressure-sensitive adhesive layer containing an acrylic polymer, a crosslinking agent, and a solvent is coated onto a surface with releaseability of the pertinent third release sheet. Here, with respect to the coating method of coating color to form the first pressure-sensitive adhesive layer, a method identical to the coating method of coating color to form the second pressure-sensitive adhesive layer may be applied.

Next, the coated coating color to form the first pressure-sensitive adhesive layer is heated, with the result that the solvent of coating color to form the pressure-sensitive adhesive layer evaporates, the acrylic polymer and the crosslinking agent react, the first pressure-sensitive adhesive layer 211 is formed, and a third pressure-sensitive adhesive sheet is obtained.

Next, the third pressure-sensitive adhesive sheet and the first pressure-sensitive adhesive sheet are superimposed so that the first pressure-sensitive adhesive layer 211 and the second pressure-sensitive adhesive layer 212 are in contact, and pressure bonding is conducted. Subsequently, the third pressure-sensitive adhesive sheet is removed to expose the first pressure-sensitive adhesive layer 211, and a fourth pressure-sensitive adhesive sheet is obtained wherein the second pressure-sensitive adhesive layer 212 and the first pressure-sensitive adhesive layer 211 are laminated onto the first release sheet 230a.

Next, the fourth pressure-sensitive adhesive sheet and the second pressure-sensitive adhesive sheet are superimposed so that the first pressure-sensitive adhesive layer 211 and the third pressure-sensitive adhesive layer 213 are in contact, and pressure bonding is conducted to obtain the double-faced pressure-sensitive adhesive sheet with release sheet 220.

In this instance, there was illustration of an example where the first pressure-sensitive adhesive layer 211 and the second pressure-sensitive adhesive layer 212 are laminated, after which the third pressure-sensitive adhesive layer 213 is laminated, but it is also acceptable to laminate the first pressure-sensitive adhesive layer 211 and the third pressure-sensitive adhesive layer 213, and subsequently laminate the second pressure-sensitive adhesive layer 212.

Manufacturing method (4) will now be described in detail as exemplified by the case of manufacture of the aforementioned double-faced pressure-sensitive adhesive sheet with release sheet 220. The aforementioned double-faced pressure-sensitive adhesive sheet with release sheet 220 is manufactured, for example, by the following manufacturing method.

First, coating color to form a first pressure-sensitive adhesive layer containing an acrylic polymer, a crosslinking agent, and a solvent, coating color to form a second pressure-sensitive adhesive layer containing an acrylic polymer, a crosslinking agent, and a solvent, and coating color to form a third pressure-sensitive adhesive layer containing an acrylic polymer, a crosslinking agent, and a solvent are simultaneously multilayer coated onto a surface with releaseability of the first release sheet 230a, and a coating film is formed that is laminated in the order of coating color to form the second pressure-sensitive adhesive layer, coating color to form the first pressure-sensitive adhesive layer, and coating color to form the third pressure-sensitive adhesive layer.

Here, as the method for conducting simultaneous multilayer coating of coating color to form the first pressure-sensitive adhesive layer, coating color to form the second pressure-sensitive adhesive layer, and coating color to form the third pressure-sensitive adhesive layer, one may cite the die coating method, slide beat coating method, curtain coating method, and so on. Among these, the dye coating method is preferable, because there is little risk of clogging and the like due to drying of the coating color, and because formation of a comparatively thick layer is easy compared to other coating methods. Coating by the respective coating methods can be carried out using known coating devices.

Next, the formed coating film is heated, with the result that the solvents of coating colors to form the respective pressure-sensitive adhesive layers evaporate, and the acrylic polymers and the crosslinking agents react to form the second pressure-sensitive adhesive layer 212, the first pressure-sensitive adhesive layer 211, and the third pressure-sensitive adhesive layer 213. By this means, a laminate is obtained wherein the first release sheet 230a is laminated onto the second pressure-sensitive adhesive layer 212 of the double-faced pressure-sensitive adhesive sheet 220.

Next, the second release sheet 230b is laminated onto the third pressure-sensitive adhesive layer 213 of the pertinent laminate to obtain the double-faced pressure-sensitive adhesive sheet with release sheet 220.

In this instance, there was illustration of an example where the double-faced pressure-sensitive adhesive sheet 220 is formed on the first release sheet 230a, but it is also acceptable to form the double-faced pressure-sensitive adhesive sheet 220a on the second release sheet 230b, and subsequently laminate the first release sheet 230a onto the second pressure-sensitive adhesive layer 212.

Transparent Laminate

Next, an embodiment of the transparent laminate of the present invention is described. With respect to a transparent laminate 11 of the present embodiment, a first transparent substrate 140 and a second transparent substrate 150 are bonded by the aforementioned double-faced pressure-sensitive adhesive sheet 110 (see FIG. 3). The first pressure-sensitive adhesive layer 111 contacts the first transparent substrate 140, and the second pressure-sensitive adhesive layer 112 contacts the second transparent substrate 150.

Irregularities are formed in a surface 140a of the first transparent substrate 140 on the double-faced pressure-sensitive adhesive sheet 110 side. In the present embodiment, the first transparent substrate 140 is a conductive sheet for a position input device used in a touchscreen, and has a conductive layer 142 provided on one side of an insulating substrate 141. As the position input device, there is the resistance film type, electrostatic capacitance type, and so on. In whichever type, an electrode 143 is provided on the surface of the conductive sheet on the double-faced pressure-sensitive adhesive sheet 110 side, and irregularities are formed.

As the insulating substrate 141 configuring the conductive sheet, one may cite, for example, a glass plate, a polyethylene terephthalate film, and so on.

The second transparent substrate 150 may be a polycarbonate monolayer sheet, polymethyl methacrylate monolayer sheet, polycarbonate-polymethyl methacrylate laminar sheet, triacetyl cellulose sheet, or cycloolefin polymer sheet. A polycarbonate monolayer sheet, polymethyl methacrylate monolayer sheet, polycarbonate-polymethyl methacrylate laminar sheet, or cycloolefin polymer sheet constitutes a gas generating substrate that generates gas during heating. A triacetyl cellulose sheet is a moisture releasing substrate that releases moisture according to environmental humidity.

In the case where the second transparent substrate 150 is a polycarbonate monolayer sheet, polymethyl methacrylate monolayer sheet, or polycarbonate-polymethyl methacrylate laminar sheet, it is used as a front plate that serves a protective function. The thickness of a second transparent substrate 150 that is used as a front plate is preferably 0.1-3 mm.

If the thickness of the second transparent substrate 150 is at or above the aforementioned lower limit value, sufficient rigidity and hardness are exhibited, and if it is at or below the aforementioned upper limit value, transparency is increased.

In the case where the second transparent substrate 150 is a triacetyl cellulose sheet or a cycloolefin polymer sheet, it configures a portion of a polarizing plate.

A hard coating layer composed of acrylic resin or the like may be provided for scratch prevention on one or both sides of the second transparent substrate 150. In addition, irregularities arising from printing ink or the like may be provided on a surface 150a of the second transparent substrate 150 on the double-faced pressure-sensitive adhesive sheet 110 side. For purposes of moiré prevention, tiny irregularities may be provided over the entirety of the surface 150 [sic]. The double-faced pressure-sensitive adhesive sheet 110 also has excellent conformance to irregularities with respect to the irregularities provided on the surface of the second transparent substrate 150 on the double-faced pressure-sensitive adhesive sheet 110 side.

In the double-faced pressure-sensitive adhesive sheet provided with a first pressure-sensitive adhesive layer and a second pressure-sensitive adhesive layer, it is preferable that the first pressure-sensitive adhesive layer be used in a touchscreen, and that the second pressure-sensitive adhesive layer be used in a polarizing plate.

Another transparent laminate of the present invention will now be described. The transparent laminate of the present invention is a transparent laminate wherein a first transparent substrate and a second transparent substrate are bonded by the aforementioned double-faced pressure-sensitive adhesive sheet, wherein the second pressure-sensitive adhesive layer contacts the first transparent substrate, and the third pressure-sensitive adhesive layer contacts the second transparent substrate, wherein at least one or the other of the first transparent substrate and second transparent substrate is provided with irregularities on a surface on the double-faced pressure-sensitive adhesive sheet side, and wherein at least one or the other of the first transparent substrate and second transparent substrate is composed of polycarbonate, polymethyl methacrylate, polyethylene terephthalate, triacetyl cellulose, or cycloolefin polymer.

Irregularities are formed on the surface of at least one or the other of the two transparent substrates bonded by the double-faced pressure-sensitive adhesive sheet, and the double-faced pressure-sensitive adhesive sheet has excellent conformance to irregularities with respect to the irregular surface, because the cohesive strength of the first pressure-sensitive adhesive layer is weak, and the thickness of the second pressure-sensitive adhesive layer is thin. Moreover, at least one or the other of the two transparent substrates joined by the double-faced pressure-sensitive adhesive sheet is composed of a gas generating material that generates gas during heating such as polycarbonate or polymethyl methacrylate, or a moisture releasing material that releases moisture such as triacetyl cellulose, and occurrence of swelling between the pertinent transparent substrates and the double-faced pressure-sensitive adhesive sheet is inhibited by providing the second pressure-sensitive adhesive layer and the third pressure-sensitive adhesive layer on the outer layers of the double-faced pressure-sensitive adhesive sheet. Even in the case where heating is conducted after adhesion of substrates with different rates of thermal expansion and contraction (such as a polycarbonate sheet and a polyethylene terephthalate sheet), the differences in deformation amounts of the two substrates due to expansion and contraction are absorbed, and curling does not occur, because the first pressure-sensitive adhesive layer has weak cohesive strength, and is easily deformed. Consequently, the transparent laminate of the present invention exhibits excellent interlayer adhesiveness immediately after manufacture without occurrence of curling or the like, and also exhibits excellent stability.

On the other hand, when the thickness of the second pressure-sensitive adhesive layer is excessive, the conformance to irregularities declines, and interstices may occur between it and the irregular surface. Moreover, in the case where the thickness of the second pressure-sensitive adhesive layer is excessively thin, and where the transparent substrate and the first pressure-sensitive adhesive layer come into direct contact without the existence of a second or third pressure-sensitive adhesive layer, swelling may arise between the pertinent transparent substrate and the double-faced pressure-sensitive adhesive sheet due to gas generation or moisture release, and adhesion of the pressure-sensitive adhesive to the cutting blade during punching may occur.

With respect to the aforementioned first transparent substrate and second transparent substrate, irregularities may be formed on the surface of the double-faced pressure-sensitive adhesive sheet side on either one or both sides.

In the case where irregularities are formed on the surface of at least one or the other of the first transparent substrate and second transparent substrate on the double-faced pressure-sensitive adhesive sheet side, and where the surface of the other double-faced pressure-sensitive adhesive sheet side is smooth, and where the thicknesses of the second pressure-sensitive adhesive layer and the third pressure-sensitive adhesive layer differ, with respect to the second pressure-sensitive adhesive layer and the third pressure-sensitive adhesive layer of the double-faced pressure-sensitive adhesive sheet, the pressure-sensitive adhesive layer with the lesser thickness is preferably disposed so as to contact the transparent substrate on which the irregularities are formed.

In the case where both the first transparent substrate and the second transparent substrate have irregularities formed on the surface on the double-faced pressure-sensitive adhesive sheet side, and where there are differences in the size of the irregularities (for example, differences in the height of the irregularities) on the respective surfaces, and where the thicknesses of the second pressure-sensitive adhesive layer and the third pressure-sensitive adhesive layer are different, with respect to the second pressure-sensitive adhesive layer and the third pressure-sensitive adhesive layer of the double-faced pressure-sensitive adhesive sheet, the pressure-sensitive adhesive layer with the lesser thickness is preferably disposed so as to contact the transparent substrate on which the larger irregularities are formed.

At least one or the other of the first transparent substrate and the second transparent substrate is composed of polycarbonate, polymethyl methacrylate, polyethylene terephthalate, triacetyl cellulose, or cycloolefin polymer (hereinafter collectively referred to as “Specified Resin(s)”). As the pertinent transparent substrate, one may cite, for example, a polycarbonate monolayer sheet, polymethyl methacrylate monolayer sheet, polycarbonate/polymethyl methacrylate laminar sheet, triacetyl cellulose sheet, cycloolefin polymer sheet, and so on. One may also cite a laminar sheet wherein these transparent substrate surfaces are partially coated with another material layer (such as a metal layer or a layer of other resin apart from the aforementioned Specified Resins).

In the present invention, either or both of the two transparent substrates bonded by the double-faced pressure-sensitive adhesive sheet may be a transparent substrate composed of the aforementioned Specified Resin(s). The present invention is particularly useful if both the first transparent substrate and second transparent substrate are transparent substrates composed of the aforementioned Specified Resin(s), and if the Specified Resin(s) respectively composing the first transparent substrate and second transparent substrate are different.

In the case where either the first transparent substrate or the second transparent substrate is a transparent substrate composed of the aforementioned Specified Resin(s) (if the transparent substrate is laminated from two or more materials, the substrate on the double-faced pressure-sensitive adhesive sheet side), one may, for example, cite a glass plate, polypropylene sheet, polyethylene sheet or the like as the other transparent substrate. One may also cite a laminar sheet or the like wherein these transparent substrate surfaces are partially or entirely coated with another material layer (such as a metal layer or a layer of other resin apart from the Specified Resin(s)).

An embodiment of the transparent laminate of the present invention will now be described. With respect to a transparent laminate 21 of the present embodiment, a first transparent substrate 240 and a second transparent substrate 250 are bonded by the aforementioned double-faced pressure-sensitive adhesive sheet 210. The second pressure-sensitive adhesive layer 212 contacts the first transparent substrate 240, and the third pressure-sensitive adhesive layer 213 contacts the second transparent substrate 50 [sic].

Irregularities are formed on a surface 240a of the first transparent substrate 240 on the double-faced pressure-sensitive adhesive sheet 210 side. In the present embodiment, the first transparent substrate 240 is a conductive sheet for a position input device used in a touchscreen, and has a conductive layer 242 provided on one side of an insulating substrate 241, and an electrode 243 provided on the conductive layer 242.

The conductive layer 242 is provided so as to partially cover the surface of the insulating substrate 241, and a portion of the insulating substrate 241 is exposed to the surface 240a of the first transparent substrate 240 on the double-faced pressure-sensitive adhesive sheet 210 side.

As the insulating substrate 241 configuring the conductive sheet, one may cite, for example, a glass plate, a polyethylene terephthalate film, a polycarbonate monolayer sheet, a polymethyl methacrylate monolayer sheet, a polycarbonate-polymethyl methacrylate laminar sheet, a triacetyl cellulose sheet, a cycloolefin polymer sheet, and so on, any of which is acceptable.

The second transparent substrate 250 may be a polycarbonate monolayer sheet, polymethyl methacrylate monolayer sheet, polycarbonate-polymethyl methacrylate laminar sheet, polyethylene terephthalate sheet, triacetyl cellulose sheet, or cycloolefin polymer sheet. A polycarbonate monolayer sheet, polymethyl methacrylate monolayer sheet, polycarbonate-polymethyl methacrylate laminar sheet, or cycloolefin polymer sheet constitutes a gas generating substrate that generates gas during heating. A triacetyl cellulose sheet is a moisture releasing substrate that releases moisture according to environmental humidity.

In the case where the second transparent substrate 250 is a polycarbonate monolayer sheet, polymethyl methacrylate monolayer sheet, polycarbonate-polymethyl methacrylate laminar sheet, or polyethylene terephthalate sheet, it is used as a front plate that serves a protective function. The thickness of a second transparent substrate 250 that is used as a front plate is preferably 0.1-3 mm.

If the thickness of the second transparent substrate 250 is at or above the aforementioned lower limit value, sufficient rigidity and hardness are exhibited, and if it is at or below the aforementioned upper limit value, transparency is increased.

In the case where the second transparent substrate 250 is a triacetyl cellulose sheet or a cycloolefin polymer sheet, it configures a portion of a polarizing plate.

In a double-faced pressure-sensitive adhesive sheet provided with a first pressure-sensitive adhesive layer, second pressure-sensitive adhesive layer, and third pressure-sensitive adhesive layer, the second pressure-sensitive adhesive layer is preferably used in a touchscreen, and the third pressure-sensitive adhesive layer is preferably used in a polarizing plate.

(Operational Effects)

With the aforementioned transparent laminate 11, as the double-faced pressure-sensitive adhesive sheet 110 is provided with a soft first pressure-sensitive adhesive layer 111, it has excellent the conformance to irregularities with respect to the irregular surface of the first transparent substrate 140, and has excellent adhesiveness. Moreover, as the second pressure-sensitive adhesive layer 112 is bonded to the second substrate 130, occurrence of swelling is prevented between the second pressure-sensitive adhesive layer 112 and the second substrate 130.

In addition, with the aforementioned transparent laminate 21, as the double-faced pressure-sensitive adhesive sheet 210 is provided with a first pressure-sensitive adhesive layer 211 of weak cohesive strength, and a thin second pressure-sensitive adhesive layer 212, it has excellent conformance to irregularities with respect to the irregular surface of the first transparent substrate 240, and has excellent adhesiveness. By providing a second pressure-sensitive adhesive layer 212 of high cohesive strength, occurrence of swelling between the second pressure-sensitive adhesive layer 212 and the first transparent substrate 240 is prevented even in the case where the insulating substrate 241 of the first transparent substrate 240 is composed of the aforementioned Specified Resin(s).

Moreover, as a third pressure-sensitive adhesive layer 213 of high cohesive strength is bonded to the second transparent substrate 230, occurrence of swelling between the third pressure-sensitive adhesive layer 213 and the second substrate 230 is prevented.

### Other Embodiments

The transparent laminate of the present invention is not limited to the foregoing embodiment. For example, it is also acceptable if the surface of the first transparent substrate 140 on the double-faced pressure-sensitive adhesive sheet 110 side is not an irregular surface, and if only the surface of the second transparent substrate 150 on the double-faced pressure-sensitive adhesive sheet 110 side is an irregular surface.

It is also acceptable to provide a transparent substrate between the first pressure-sensitive adhesive layer 111 and the second pressure-sensitive adhesive layer 112 to an extent that does not hinder the effects of the present invention.

In addition, for example, it is also acceptable if the surface of the first transparent substrate 240 on the double-faced pressure-sensitive adhesive sheet 210 side is not an irregular surface, and if only the surface of the second transparent substrate 250 on the double-faced pressure-sensitive adhesive sheet 210 side is an irregular surface. For example, irregularities arising from printing ink or the like may be provided on the surface 250a of the second transparent substrate 250 on the double-faced pressure-sensitive adhesive sheet 210 side. Moreover, for purposes of moiré prevention, tiny irregularities may be provided over the entirety of the surface 250a. The double-faced pressure-sensitive adhesive sheet 210 also has excellent conformance to irregularities with respect to the irregularities provided on the surface of the second transparent substrate 250 on the double-faced pressure-sensitive adhesive sheet 210 side.

In the case where the second transparent substrate 250 is composed of the Specified Resin(s), a hard coating layer composed of acrylic resin or the like may be provided on one or both sides for purposes of scratch prevention.

In the case where the second transparent substrate 250 is used as a front plate, printing may be conducted over part or all of the surface that contacts the pressure-sensitive adhesive layer for purposes of designability or the like. The print level difference (ink layer thickness) on the surface of the second transparent substrate 250 that contacts the pressure-sensitive adhesive layer by this printing ink layer is ordinarily on the order of 5-100 μm. In the case where the double-faced pressure-sensitive adhesive sheet 210 of the present invention is used, it also exhibits excellent conformance to irregularities with respect to the pertinent print level difference.

Moreover, it is also acceptable to provide a transparent substrate between the first pressure-sensitive adhesive layer 211 and the second pressure-sensitive adhesive layer 212, and/or between the first pressure-sensitive adhesive layer 211 and the third pressure-sensitive adhesive layer 213, to an extent that does not hinder the effects of the present invention.

### EXAMPLES

The present invention is described in further detail below by means of examples and comparative examples, but the present invention is not limited to these examples. Unless otherwise specifically indicated, “parts” and “%” in the following examples respectively indicate “weight parts” and “weight %.”

Weight average molecular weight M_{w} is obtained with a polystyrene standard by measurement of a sample in which THF (tetrahydrofuran) is dissolved, using gel permeation chromatography (pump: PU-980, detector: RI-2031 Plus, manufactured by JASCO Corp.).

G′ and G″ are measured by rheometer (Dynalyser DAR-200, manufactured by Reologica Corp.) under conditions of a frequency of 1 Hz, strain of 0.1%, and rate of temperature increase of 3° C./minute, and tan δ is obtained as the ratio of G′ and G″ (G′/G″).

### Example A1

### Synthesis of Pressure-Sensitive Adhesive Solution of First Pressure-Sensitive Adhesive Layer

After injecting nitrogen gas into a reaction apparatus provided with an agitator, a thermometer, a reflux condenser, an instillator, and a nitrogen intake tube, 105 weight parts of ethyl acetate which is the solvent were added. Subsequently, within the reaction apparatus, 55 weight parts of methyl acrylate, 45 weight parts of 2-ethylhexyl acrylate, and 5.0 weight parts of 4-hydroxybutyl acrylate were added as monomer components, and 0.3 weight parts of azobisisobutylonitrile (hereinafter denoted as “AIBN”) were added as the initiator to the ethyl acetate so that monomer concentration was approximately 50 weight %. Thereafter, agitation was conducted for 8 hours at 50° C. under nitrogen gas flow while stirring, after which the polymer reaction was suspended by rapid cooling with an ice water bath to obtain an ester acrylate copolymer solution with a weight average molecular weight M_{w} of 700,000.

0.4 weight parts of a hexamethylene diisocyanate trifunctional adduct (P301-75E manufactured by Asahi Kasei Corp.) were added as a crosslinking agent to the 100 weight parts of solid content of this copolymer solution, and diluted to a solution with an ethyl acetate concentration of 35 weight % to obtain the solution of pressure-sensitive adhesive 1A-1.

[Synthesis of Pressure-Sensitive Adhesive Solution of Second Pressure-Sensitive Adhesive Layer]

Except for a change in the usage amount of AIBN to 0.12 weight parts, an ester acrylate copolymer solution with a weight average molecular weight M_{w} of 1,500,000 was obtained by the same synthesis method as that of the pressure-sensitive adhesive solution of the first pressure-sensitive adhesive layer. 0.4 weight parts of a hexamethylene diisocyanate trifunctional adduct (P301-75E manufactured by Asahi Kasei Corp.) were added as a crosslinking agent to the 100 weight parts of solid content of this copolymer solution, and diluted to a solution with an ethyl acetate concentration of 25 weight % to obtain the solution of pressure-sensitive adhesive 1B-1.

[Preparation of Double-Faced Pressure-Sensitive Adhesive Sheet]

A release film provided with a release agent layer in PET film (38μ RL-07(2), manufactured by Oji Specialty Paper Co., Ltd.) was prepared as the first release sheet, and the solution of the aforementioned pressure-sensitive adhesive 1A-1 was coated onto the release agent layer of the first release sheet with a knife coater, and heated for 3 minutes at 100° C. to form the first pressure-sensitive adhesive layer, and obtain the first pressure-sensitive adhesive sheet. With respect to the formed first pressure-sensitive adhesive layer, at a frequency of 1 Hz and 25° C., G′ was 2.7×10⁵ Pa, G″ was 1.9×10⁵ Pa, and tan δ was 0.70; at a frequency of 1 Hz and 50° C., G′ was 1.2×10⁵ Pa, G″ was 4.7×10⁴ Pa, and tan δ was 0.39; and at a frequency of 1 Hz and 80° C., G′ was 7.3×10⁴ Pa, G″ was 2.7×10⁴ Pa, and tan δ was 0.37.

In addition, a release film provided with a release agent layer of higher releaseability than the aforementioned first release sheet in PET film (38μ RL-07(L), manufactured by Oji Specialty Paper Co., Ltd.) was prepared as the second release sheet, and the solution of the aforementioned pressure-sensitive adhesive 1B-1 was coated onto the release agent layer of the first [sic] release sheet with a knife coater, and heated for 3 minutes at 100° C. to form the second pressure-sensitive adhesive layer, and obtain the second pressure-sensitive adhesive sheet. With respect to the formed second pressure-sensitive adhesive layer, at a frequency of 1 Hz and 25° C., G′ was 1.3×10⁶ Pa, G″ was 7.3×10⁵ Pa, and tan δ was 0.56; at a frequency of 1 Hz and 50° C., G′ was 8.4×10⁵ Pa, G″ was 2.8×10⁵ Pa, and tan δ was 0.33; and at a frequency of 1 Hz and 80° C., G′ was 6.6×10⁵ Pa, G″ was 1.4×10⁵ Pa, and tan δ was 0.21.

Subsequently, the first release sheet and the second release sheet were superimposed so that the first pressure-sensitive adhesive layer and the second pressure-sensitive adhesive layer were in contact, and pressure bonding was conducted to obtain a double-faced pressure-sensitive adhesive sheet with release sheet. With respect to the double-faced pressure-sensitive adhesive sheet (first pressure-sensitive adhesive layer+second pressure-sensitive adhesive layer), at a frequency of 1 Hz and 25° C., G′ was 4.1×10⁵ Pa, G″ was 2.8×10⁵ Pa, and tan δ was 0.68; at a frequency of 1 Hz and 50° C., G′ was 2.5×10⁵ Pa, G″ was 8.7×10⁴ Pa, and tan δ was 0.36; and at a frequency of 1 Hz and 80° C., G′ was 1.7×10⁵ Pa, G″ was 4.5×10⁴ Pa, and tan δ was 0.26.

### Example A2

### Synthesis of Pressure-Sensitive Adhesive Solution of First Pressure-Sensitive Adhesive Layer

Except for a change in the usage amount of AIBN to 0.4 weight parts, an ester acrylate copolymer solution with a weight average molecular weight M_{w} of 500,000 was obtained by the same synthesis method as that of Example A1. 0.4 weight parts of a hexamethylene diisocyanate trifunctional adduct (P301-75E manufactured by Asahi Kasei Corp.) were added as a crosslinking agent to the 100 weight parts of solid content of this copolymer solution, and diluted to a solution with an ethyl acetate concentration of 35 weight % to obtain the solution of pressure-sensitive adhesive 1A-2.

[Preparation of Double-Faced Pressure-Sensitive Adhesive Sheet]

Apart from formation of the first pressure-sensitive adhesive layer using the solution of the pressure-sensitive adhesive 1A-2, a double-faced pressure-sensitive adhesive sheet with release sheet was obtained in the same manner as example A1.

With respect to the formed first pressure-sensitive adhesive layer, at a frequency of 1 Hz and 25° C., G′ was 1.3×10⁵ Pa, G″ was 9.4×10⁴ Pa, and tan δ was 0.72; at a frequency of 1 Hz and 50° C., G′ was 8.9×10⁴ Pa, G″ was 5.2×10⁴ Pa, and tan δ was 0.58; and at a frequency of 1 Hz and 80° C., G′ was 5.8×10⁴ Pa, G″ was 1.7×10⁴ Pa, and tan δ was 0.29. G′, G″, and tan δ of the second pressure-sensitive adhesive layer was identical to G′, G″, and tan δ of the second pressure-sensitive adhesive layer of example A1. In addition, with respect to the double-faced pressure-sensitive adhesive sheet (first pressure-sensitive adhesive layer+second pressure-sensitive adhesive layer), at a frequency of 1 Hz and 25° C., G′ was 3.2×10⁵ Pa, G″ was 2.0×10⁵ Pa, and tan δ was 0.63; at a frequency of 1 Hz and 50° C., G′ was 2.1×10⁵ Pa, G″ was 9.0×10⁴ Pa, and tan δ was 0.43; and at a frequency of 1 Hz and 80° C., G′ was 1.6×10⁵ Pa, G″ was 3.7×10⁴ Pa, and tan δ was 0.23.

### Example A3

### Synthesis of Pressure-Sensitive Adhesive Solution of Second Pressure-Sensitive Adhesive Layer

Except for a change in the usage amount of AIBN to 0.2 weight parts, an ester acrylate copolymer solution with a weight average molecular weight M_{w} of 900,000 was obtained by the same synthesis method as that of Example A1. 0.4 weight parts of a hexamethylene diisocyanate trifunctional adduct (P301-75E manufactured by Asahi Kasei Corp.) were added as a crosslinking agent to the 100 weight parts of solid content of this copolymer solution, and diluted to a solution with an ethyl acetate concentration of 25 weight % to obtain the solution of pressure-sensitive adhesive 1B-2.

[Preparation of Double-Faced Pressure-Sensitive Adhesive Sheet]

Apart from formation of the second pressure-sensitive adhesive layer using the solution of the pressure-sensitive adhesive 1B-2, a double-faced pressure-sensitive adhesive sheet with release sheet was obtained in the same manner as example A2.

G′, G″, and tan δ of the formed first pressure-sensitive adhesive layer were identical to G′, G″, and tan δ of the first pressure-sensitive adhesive layer of example A2. With respect to the second pressure-sensitive adhesive layer, at a frequency of 1 Hz and 25° C., G′ was 5.1×10⁵ Pa, G″ was 3.8×10⁵ Pa, and tan δ was 0.74; at a frequency of 1 Hz and 50° C., G′ was 3.7×10⁵ Pa, G″ was 1.3×10⁵ Pa, and tan δ was 0.35; and at a frequency of 1 Hz and 80° C., G′ was 2.4×10⁵ Pa, G″ was 7.8×10⁴ Pa, and tan δ was 0.32. In addition, with respect to the double-faced pressure-sensitive adhesive sheet (first pressure-sensitive adhesive layer+second pressure-sensitive adhesive layer), at a frequency of 1 Hz and 25° C., G′ was 2.4×10⁵ Pa, G″ was 1.8×10⁵ Pa, and tan δ was 0.75; at a frequency of 1 Hz and 50° C., G′ was 1.6×10⁵ Pa, G″ was 7.5×10⁴ Pa, and tan δ was 0.46; and at a frequency of 1 Hz and 80° C., G′ was 1.1×10⁵ Pa, G″ was 3.5×10⁴ Pa, and tan δ was 0.31.

Except for a change in the usage amount of AIBN to 0.1 weight parts, an ester acrylate copolymer solution with a weight average molecular weight M_{w} of 1,800,000 was obtained by the same synthesis method as that of Example A1. 0.4 weight parts of a hexamethylene diisocyanate trifunctional adduct (P301-75E manufactured by Asahi Kasei Corp.) were added as a crosslinking agent to the 100 weight parts of solid content of this copolymer solution, and diluted to a solution with an ethyl acetate concentration of 25 weight % to obtain the solution of pressure-sensitive adhesive 1B-3.

Apart from formation of the second pressure-sensitive adhesive layer using the solution of the pressure-sensitive adhesive 1B-3, a double-faced pressure-sensitive adhesive sheet with release sheet was obtained in the same manner as Example A2.

G′, G″, and tan δ of the formed first pressure-sensitive adhesive layer were identical to G′, G″, and tan δ of the first pressure-sensitive adhesive layer of Example A2. With respect to the second pressure-sensitive adhesive layer, at a frequency of 1 Hz and 25° C., G′ was 1.7×10⁶ Pa, G″ was 8.9×10⁵ Pa, and tan δ was 0.52; at a frequency of 1 Hz and 50° C., G′ was 1.0×10⁶ Pa, G″ was 3.2×10⁵ Pa, and tan δ was 0.32; and at a frequency of 1 Hz and 80° C., G′ was 7.8×10⁵ Pa, G″ was 1.7×10⁵ Pa, and tan δ was 0.22. In addition, with respect to the double-faced pressure-sensitive adhesive sheet (first pressure-sensitive adhesive layer+second pressure-sensitive adhesive layer), at a frequency of 1 Hz and 25° C., G′ was 4.4×10⁵ Pa, G″ was 2.5×10⁵ Pa, and tan δ was 0.56; at a frequency of 1 Hz and 50° C., G′ was 2.8×10⁵ Pa, G″ was 1.1×10⁵ Pa, and tan δ was 0.39; and at a frequency of 1 Hz and 80° C., G′ was 2.1×10⁵ Pa, G″ was 4.8×10⁴ Pa, and tan δ was 0.23.

### Comparative Example A1

The solution of pressure-sensitive adhesive 1A-1 was coated onto the exposed surface of the release agent layer of the aforementioned first release sheet by knife coater, and heated for 3 minutes at 100° C. to form a first pressure-sensitive adhesive layer. Subsequently, the aforementioned second release sheet was superimposed onto the obtained first pressure-sensitive adhesive layer, and pressure bonding was conducted to obtain a double-faced pressure-sensitive adhesive sheet with release sheet.

### Comparative Example A2

Except for the solution of the pressure-sensitive adhesive 1A-1 to the solution of the pressure-sensitive adhesive 1A-2, a double-faced pressure-sensitive adhesive sheet with release sheet was obtained in the same manner as comparative example A1.

### Comparative Example A3

Except for the solution of the pressure-sensitive adhesive 1A-1 to the solution of the pressure-sensitive adhesive 1B-1, a double-faced pressure-sensitive adhesive sheet with release sheet was obtained in the same manner as comparative example A1.

### Comparative Example A4

Except for the solution of the pressure-sensitive adhesive 1A-1 to the solution of the pressure-sensitive adhesive 1B-2, a double-faced pressure-sensitive adhesive sheet with release sheet was obtained in the same manner as comparative example A1.

### Comparative Example A5

Except for the solution of the pressure-sensitive adhesive 1A-1 to the solution of the pressure-sensitive adhesive 1B-3, a double-faced pressure-sensitive adhesive sheet with release sheet was obtained in the same manner as comparative example A1.

(Evaluation)

The swelling prevention properties and conformance to irregularities properties of the double-faced pressure-sensitive adhesive sheets of the respective examples and the respective comparative examples were evaluated as follows. The evaluation results are shown in Table A1.

[Swelling Prevention Properties]

The second release sheet was removed, and a polycarbonate sheet (thickness: 1 mm) was bonded to the exposed pressure-sensitive adhesive layer, after which the first release sheet was removed, and a polyethylene terephthalate sheet (thickness: 100 μm) was bonded to the exposed pressure-sensitive adhesive layer to obtain a transparent laminate.

After pressure was applied to this transparent laminate for 30 minutes under conditions of a temperature of 50° C. and a pressure of 0.5 MPa in a pressurized defoaming apparatus (YK-350S, manufactured by Kurihara Seisakusho K.K.), it was left standing for 250 hours in an environment with a temperature of 60° C. and a relative humidity of 90%. Subsequently, the condition of the transparent laminate was visually observed, and evaluated according to the following standard.

A: no occurrence whatever of gas swelling

B: occurrence of fine bubbles (gas swelling) in small amounts

C: occurrence of gas swelling over the entire surface

[Properties of the Conformance to Irregularities]

To obtain a polyethylene terephthalate sheet with irregularities, printing was conducted on one surface of a polyethylene terephthalate sheet so that irregularities with a height difference of 30 μm were formed.

The second release sheet was removed, and a polyethylene terephthalate sheet without irregularities was bonded to the exposed pressure-sensitive adhesive layer, after which the first release sheet was removed, and the irregular surface of a polyethylene terephthalate sheet with irregularities was bonded to the exposed pressure-sensitive adhesive layer to obtain a transparent laminate.

Pressure was applied to this transparent laminate for 10 minutes under conditions of a temperature of 40° C. and a pressure of 0.5 MPa in a pressurized defoaming apparatus. The degree of adhesiveness of the polyethylene terephthalate sheet with irregularities was then observed using a microscope (magnification: 25-fold), and evaluated according to the following standard.

A: the uneven portions of the irregularities were completely filled up

B: small amounts of air remained in the uneven portions of the irregularities

C: air remained in the entirety of the uneven portions of the irregularities

TABLE A1

| | | Exam- | Exam- | Exam- | Exam- | Comparative | Comparative | Comparative | Comparative | Comparative |
|---|---|---|---|---|---|---|---|---|---|---|
| | | ple A1 | ple A2 | ple A3 | ple A4 | example A1 | example A2 | example A3 | example A4 | example A5 |
| First | Pressure-sensitive adhesive | 1A-1 | 1A-2 | 1A-2 | 1A-2 | 1A-1 | 1A-2 | 1B-1 | 1B-2 | 1B-3 |
| pressure- | Thickness (μm) | 75 | 75 | 70 | 80 | 100 | 100 | 100 | 100 | 100 |
| sensitive | | | | | | | | | | |
| adhesive | | | | | | | | | | |
| Second | Pressure-sensitive adhesive | 1B-1 | 1B-1 | 1B-2 | 1B-3 | — | — | — | — | — |
| pressure- | Thickness (μm) | 15 | 15 | 30 | 20 | — | — | — | — | — |
| sensitive | | | | | | | | | | |
| adhesive | | | | | | | | | | |

| | | | | | | | | | |
|---|---|---|---|---|---|---|---|---|---|
| Swelling prevention properties | A | A | A | A | B | C | A | A | A |
| Proerties the conformance to | A | A | A | A | A | A | C | B | C |
| irregularities | | | | | | | | | |

Swelling prevention properties and properties of the conformance to irregularities were excellent with the double-faced pressure-sensitive adhesive sheets of Examples A1-A4 provided with a first pressure-sensitive adhesive layer and a second pressure-sensitive adhesive layer containing a pressure-sensitive adhesive with the aforementioned weight average molecular weight.

In contrast, swelling prevention properties were poor with comparative example A1 which used a monolayer pressure-sensitive adhesive layer with a thickness of 100 μm composed of the pressure-sensitive adhesive 1A-1 as the double-faced pressure-sensitive adhesive sheet, and with comparative example A2 which used a monolayer pressure-sensitive adhesive layer with a thickness of 100 μm composed of the pressure-sensitive adhesive 1A-2 as the double-faced pressure-sensitive adhesive sheet.

Properties of the conformance to irregularities were poor with comparative example A3 which used a monolayer pressure-sensitive adhesive layer with a thickness of 100 μm composed of the pressure-sensitive adhesive 1B-1 as the double-faced pressure-sensitive adhesive sheet, with comparative example A4 which used a monolayer pressure-sensitive adhesive layer with a thickness of 100 μm composed of the pressure-sensitive adhesive 1B-2 as the double-faced pressure-sensitive adhesive sheet, and with comparative example A5 which used a monolayer pressure-sensitive adhesive layer with a thickness of 100 μm composed of the pressure-sensitive adhesive 1B-3 as the double-faced pressure-sensitive adhesive sheet.

### Reference Examples A1-A4

With respect to the double-faced pressure-sensitive adhesive sheets of the aforementioned Examples A1-A4, the first release sheet was removed, and a polycarbonate sheet was bonded to the exposed pressure-sensitive adhesive layer, after which the second release sheet was removed, and a polyethylene terephthalate sheet was bonded to the exposed pressure-sensitive adhesive layer to fabricate the transparent laminates of reference examples A1-A4 whose swelling prevention properties were evaluated. As a result, as shown in Table A2, swelling prevention properties were poor in each case. From this, it was found to be important to affix a substrate facilitating gas generation such as a polycarbonate sheet to the second pressure-sensitive adhesive layer.

Upon evaluating the properties of the conformance to irregularities of the transparent laminates of reference examples A1-A4, major differences with Examples A1-A4 were not observed. Accordingly, no matter which surface of the double-faced pressure-sensitive adhesive sheet was contacted by the irregular surface, the same effects were exhibited with respect to properties of the conformance to irregularities.

TABLE A2

| | | Reference | Reference | Reference | Reference |
|---|---|---|---|---|---|
| | | example A1 | example A2 | example A3 | example A4 |
| First pressure-sensitive | Pressure-sensitive adhesive | 1A-1 | 1A-2 | 1A-2 | 1A-2 |
| adhesive layer | Thickness (μm) | 70 | 70 | 75 | 75 |
| Second pressure-sensitive | Pressure-sensitive adhesive | 1B-1 | 1B-1 | 1B-2 | 1B-3 |
| adhesive layer | Thickness (μm) | 20 | 20 | 25 | 25 |

| | | | | |
|---|---|---|---|---|
| Swelling prevention properties | B | C | C | C |
| properties of the conformance to irregularities | A | A | A | A |

### Example B1

### Preparation of Pressure-Sensitive Adhesive Solution of First Pressure-Sensitive Adhesive Layer

After injecting nitrogen gas into a reaction apparatus provided with an agitator, a thermometer, a reflux condenser, an instillator, and a nitrogen intake tube, 105 weight parts of ethyl acetate which is the solvent were added. Subsequently, within the reaction apparatus, 55 weight parts of butyl acrylate, 45 weight parts of 2-ethylhexyl acrylate, and 5.0 weight parts of 4-hydroxybutyl acrylate were added as monomer components, and 0.3 weight parts of azobisisobutylonitrile (hereinafter denoted as “AIBN”) were added as the initiator to the ethyl acetate so that monomer concentration was approximately 50 weight %. Thereafter, agitation was conducted for 8 hours at 50° C. under nitrogen gas flow while stirring, after which the polymer reaction was suspended by rapid cooling with an ice water bath to obtain an ester acrylate copolymer solution with a weight average molecular weight M_{w} of 700,000.

0.4 weight parts of a hexamethylene diisocyanate trifunctional adduct (P301-75E manufactured by Asahi Kasei Corp.) were added as a crosslinking agent to the 100 weight parts of solid content of this copolymer solution, and diluted to a solution with an ethyl acetate concentration of 35 weight % to obtain the solution of pressure-sensitive adhesive 2A-1.

[Synthesis of Pressure-Sensitive Adhesive Solution of Second Pressure-Sensitive Adhesive Layer]

Except for a change from 2-ethylhexyl acrylate to methyl acrylate, and a change in the usage amount of AIBN to 0.12 weight parts, an ester acrylate copolymer solution with a weight average molecular weight M_{w} of 1,500,000 was obtained in the same manner as the preparation of the pressure-sensitive adhesive solution of the first pressure-sensitive adhesive layer. 0.4 weight parts of a hexamethylene diisocyanate trifunctional adduct (P301-75E manufactured by Asahi Kasei Corp.) were added as a crosslinking agent to the 100 weight parts of solid content of this copolymer solution, and diluted to a solution with an ethyl acetate concentration of 25 weight % to obtain the solution of pressure-sensitive adhesive 2B-1.

[Synthesis of Pressure-Sensitive Adhesive Solution of Third Pressure-Sensitive Adhesive Layer]

Except for a change in the usage amount of AIBN to 0.2 weight parts, an ester acrylate copolymer solution with a weight average molecular weight M_{w} of 900,000 was obtained in the same manner as the preparation of the pressure-sensitive adhesive solution of the first pressure-sensitive adhesive layer. 0.4 weight parts of a hexamethylene diisocyanate trifunctional adduct (P301-75E manufactured by Asahi Kasei Corp.) were added as a crosslinking agent to the 100 weight parts of solid content of this copolymer solution, and diluted to a solution with an ethyl acetate concentration of 25 weight % to obtain the solution of pressure-sensitive adhesive 2B-2.

[Preparation of Double-Faced Pressure-Sensitive Adhesive Sheet]

A release film provided with a release agent layer in PET film (38μ RL-07(2), manufactured by Oji Specialty Paper Co., Ltd.) was prepared as the first release sheet, and the solution of the aforementioned pressure-sensitive adhesive 2A-1 was coated onto the release agent layer of the first release sheet with a knife coater, and heated for 3 minutes at 100° C. to form the first pressure-sensitive adhesive layer, and obtain the first pressure-sensitive adhesive sheet. With respect to the formed first pressure-sensitive adhesive layer, at a frequency of 1 Hz and 25° C., G′ was 2.6×10⁵ Pa, G″ was 1.8×10⁵ Pa, and tan δ was 0.69; at a frequency of 1 Hz and 50° C., G′ was 1.1×10⁵ Pa, G″ was 4.6×10⁴ Pa, and tan δ was 0.42; and at a frequency of 1 Hz and 80° C., G′ was 7.2×10⁴ Pa, G″ was 2.6×10⁴ Pa, and tan δ was 0.36.

In addition, a release film provided with a release agent layer of higher releaseability than the aforementioned first release sheet in PET film (38μ RL-07(L), manufactured by Oji Specialty Paper Co., Ltd.) was prepared as the second release sheet, and the solution of the aforementioned pressure-sensitive adhesive 2B-1 was coated onto the release agent layer of the first [sic] release sheet with a knife coater, and heated for 3 minutes at 100° C. to form the second pressure-sensitive adhesive layer, and obtain the second pressure-sensitive adhesive sheet. With respect to the formed second pressure-sensitive adhesive layer, at a frequency of 1 Hz and 25° C., G′ was 1.4×10⁶ Pa, G″ was 7.5×10⁵ Pa, and tan δ was 0.53; at a frequency of 1 Hz and 50° C., G′ was 8.5×10⁵ Pa, G″ was 2.9×10⁵ Pa, and tan δ was 0.34; and at a frequency of 1 Hz and 80° C., G′ was 6.7×10⁵ Pa, G″ was 1.5×10⁵ Pa, and tan δ was 0.22.

Furthermore, a release film identical to the first release film (38μ RL-07(L), manufactured by Oji Specialty Paper Co., Ltd.) was prepared as the third release sheet, and the solution of the aforementioned pressure-sensitive adhesive 2B-2 was coated onto the release agent layer of the third release sheet with a knife coater, and heated for 3 minutes at 100° C. to form the first pressure-sensitive adhesive layer, and obtain the first pressure-sensitive adhesive sheet. With respect to the formed third [sic] pressure-sensitive adhesive layer, at a frequency of 1 Hz and 25° C., G′ was 5.3×10⁵ Pa, G″ was 3.9×10⁵ Pa, and tan δ was 0.74; at a frequency of 1 Hz and 50° C., G′ was 3.9×10⁵ Pa, G″ was 1.4×10⁵ Pa, and tan δ was 0.36; and at a frequency of 1 Hz and 80° C., G′ was 2.6×10⁵ Pa, G″ was 7.9×10⁴ Pa, and tan δ was 0.30.

Subsequently, the first pressure-sensitive adhesive sheet and the second pressure-sensitive adhesive sheet were superimposed so that the first pressure-sensitive adhesive layer and the second pressure-sensitive adhesive layer were in contact, and pressure bonding was conducted. Thereafter, the third pressure-sensitive adhesive sheet and the adhesive sheet constituted by lamination of the first pressure-sensitive adhesive sheet and the second pressure-sensitive adhesive sheet were superimposed with removal of the first release sheet, and exposure of the pressure-sensitive adhesive layer of the first pressure-sensitive adhesive sheet, so that the pertinent first pressure-sensitive adhesive layer and the pressure-sensitive adhesive layer of the third pressure-sensitive adhesive sheet were in contact, and pressure bonding was conducted, after which a double-faced pressure-sensitive adhesive sheet with release sheet was obtained. With respect to the obtained double-faced pressure-sensitive adhesive sheet (first pressure-sensitive adhesive layer+second pressure-sensitive adhesive layer+third pressure-sensitive adhesive layer), at a frequency of 1 Hz and 25° C., G′ was 4.2×10⁵ Pa, G″ was 2.9×10⁵ Pa, and tan δ was 0.69; at a frequency of 1 Hz and 50° C., G′ was 2.7×10⁵ Pa, G″ was 8.8×10⁴ Pa, and tan δ was 0.33; and at a frequency of 1 Hz and 80° C., G′ was 1.8×10⁵ Pa, G″ was 4.7×10⁴ Pa, and tan δ was 0.26.

### Example B2

### Preparation of Pressure-Sensitive Adhesive Solution of First Pressure-Sensitive Adhesive Layer

Except for a change in the usage amount of AIBN to 0.6 weight parts, an ester acrylate copolymer solution with a weight average molecular weight M_{w} of 300,000 was obtained in the same manner as the preparation of the pressure-sensitive adhesive solution of the first pressure-sensitive adhesive layer of Example B1. 0.4 weight parts of a hexamethylene diisocyanate trifunctional adduct (P301-75E manufactured by Asahi Kasei Corp.) were added as a crosslinking agent to the 100 weight parts of solid content of this copolymer solution, and diluted to a solution with an ethyl acetate concentration of 35 weight % to obtain the solution of pressure-sensitive adhesive 2A-2.

[Preparation of Double-Faced Pressure-Sensitive Adhesive Sheet]

Apart from formation of the first pressure-sensitive adhesive layer using the solution of the pressure-sensitive adhesive 2A-2, a double-faced pressure-sensitive adhesive sheet with release sheet was obtained in the same manner as example B1.

With respect to the formed first pressure-sensitive adhesive layer, at a frequency of 1 Hz and 25° C., G′ was 1.2×10⁵ Pa, G″ was 9.2×10⁴ Pa, and tan δ was 0.77; at a frequency of 1 Hz and 50° C., G′ was 8.8×10⁴ Pa, G″ was 5.0×10⁴ Pa, and tan δ was 0.57; and at a frequency of 1 Hz and 80° C., G′ was 5.6×10⁴ Pa, G″ was 1.5×10⁴ Pa, and tan δ was 0.28. G′, G″, and tan δ of the second and third pressure-sensitive adhesive layers were identical to G′, G″, and tan δ of the second and third pressure-sensitive adhesive layers of example B1. In addition, with respect to the double-faced pressure-sensitive adhesive sheet (first pressure-sensitive adhesive layer+second pressure-sensitive adhesive layer+third pressure-sensitive adhesive layer), at a frequency of 1 Hz and 25° C., G′ was 3.1×10⁵ Pa, G″ was 2.0×10⁵ Pa, and tan δ was 0.65; at a frequency of 1 Hz and 50° C., G′ was 2.0×10⁵ Pa, G″ was 8.9×10⁴ Pa, and tan δ was 0.45; and at a frequency of 1 Hz and 80° C., G′ was 1.5×10⁵ Pa, G″ was 3.5×10⁴ Pa, and tan δ was 0.23.

### Example B3

### Preparation of Pressure-Sensitive Adhesive Solution of Second Pressure-Sensitive Adhesive Layer

Except for a change in the usage amount of AIBN to 0.1 weight parts, an ester acrylate copolymer solution with a weight average molecular weight M_{w} of 1,800,000 was obtained in the same manner as the preparation of the pressure-sensitive adhesive solution of the first pressure-sensitive adhesive layer. 0.4 weight parts of a hexamethylene diisocyanate trifunctional adduct (P301-75E manufactured by Asahi Kasei Corp.) were added as a crosslinking agent to the 100 weight parts of solid content of this copolymer solution, and diluted to a solution with an ethyl acetate concentration of 25 weight % to obtain the solution of pressure-sensitive adhesive 2B-3.

[Preparation of Double-Faced Pressure-Sensitive Adhesive Sheet]

Apart from formation of the second pressure-sensitive adhesive layer using the solution of the pressure-sensitive adhesive 2B-3, a double-faced pressure-sensitive adhesive sheet with release sheet was obtained in the same manner as Example B2.

G′, G″, and tan δ of the formed first and third pressure-sensitive adhesive layers were respectively identical to G′, G″, and tan δ of the first and third pressure-sensitive adhesive layers of Example B2. With respect to the second pressure-sensitive adhesive layer, at a frequency of 1 Hz and 25° C., G′ was 1.8×10⁵ Pa, G″ was 9.0×10⁵ Pa, and tan δ was 0.50; at a frequency of 1 Hz and 50° C., G′ was 1.1×10⁶ Pa, G″ was 3.3×10⁵ Pa, and tan δ was 0.30; and at a frequency of 1 Hz and 80° C., G′ was 8.0×10⁵ Pa, G″ was 1.9×10⁵ Pa, and tan δ was 0.24. In addition, with respect to the double-faced pressure-sensitive adhesive sheet (first pressure-sensitive adhesive layer+second pressure-sensitive adhesive layer+third pressure-sensitive adhesive layer), at a frequency of 1 Hz and 25° C., G′ was 4.5×10⁵ Pa, G″ was 2.6×10⁵ Pa, and tan δ was 0.58; at a frequency of 1 Hz and 50° C., G′ was 2.9×10⁵ Pa, G″ was 1.2×10⁵ Pa, and tan δ was 0.41; and at a frequency of 1 Hz and 80° C., G′ was 2.2×10⁵ Pa, G″ was 4.9×10⁴ Pa, and tan δ was 0.25.

### Example B4

Apart from formation of the third pressure-sensitive adhesive layer using the solution of the pressure-sensitive adhesive 2B-1, a double-faced pressure-sensitive adhesive sheet with release sheet was obtained in the same manner as Example B3.

G′, G″, and tan δ of the formed first and second pressure-sensitive adhesive layers were respectively identical to G′, G″, and tan δ of the first and second pressure-sensitive adhesive layers of Example B3. With respect to the third pressure-sensitive adhesive layer, at a frequency of 1 Hz and 25° C., G′ was identical to G′, G″, and tan δ of the second pressure-sensitive adhesive layers of Example B1. In addition, with respect to the double-faced pressure-sensitive adhesive sheet (first pressure-sensitive adhesive layer+second pressure-sensitive adhesive layer+third pressure-sensitive adhesive layer), at a frequency of 1 Hz and 25° C., G′ was 4.6×10⁵ Pa, G″ was 2.8×10⁵ Pa, and tan δ was 0.61; at a frequency of 1 Hz and 50° C., G′ was 3.0×10⁵ Pa, G″ was 1.3×10⁵ Pa, and tan δ was 0.43; and at a frequency of 1 Hz and 80° C., G′ was 2.4×10⁵ Pa, G″ was 5.1×10⁴ Pa, and tan δ was 0.21.

### Comparative Example B1

Apart from lack of lamination of a third pressure-sensitive adhesive layer, a double-faced pressure-sensitive adhesive sheet with release sheet was obtained in the same manner as Example B1.

### Comparative Example B2

Apart from lack of lamination of a third pressure-sensitive adhesive layer, a double-faced pressure-sensitive adhesive sheet with release sheet was obtained in the same manner as Example B3.

### Comparative Example B3

Apart from formation of the second pressure-sensitive adhesive layer using the solution of the pressure-sensitive adhesive 2B-2, and lack of lamination of a third pressure-sensitive adhesive layer, a double-faced pressure-sensitive adhesive sheet with release sheet was obtained in the same manner as Example B4.

### Comparative Example B4

The first pressure-sensitive adhesive layer was formed by coating the solution of the pressure-sensitive adhesive 2A-1 onto the exposed surface of the release agent layer of the aforementioned second release sheet by knife coater, and by heating it for 3 minutes at 100° C. Subsequently, the aforementioned first release sheet was superimposed onto the obtained first pressure-sensitive adhesive layer, and pressure bonding was conducted to obtain a double-faced pressure-sensitive adhesive sheet with release sheet.

### Comparative Example B5

Apart from changing the solution of the pressure sensitive adhesive 2A-1 to the solution of the pressure-sensitive adhesive 2A-2, a double-faced pressure-sensitive adhesive sheet with release sheet was obtained in the same manner as comparative example B4.

### Comparative Example B6

Apart from changing the solution of the pressure sensitive adhesive 2A-1 to the solution of the pressure-sensitive adhesive 2B-1, a double-faced pressure-sensitive adhesive sheet with release sheet was obtained in the same manner as comparative example B4.

### Comparative Example B7

Apart from changing the solution of the pressure sensitive adhesive 2A-1 to the solution of the pressure-sensitive adhesive 2B-2, a double-faced pressure-sensitive adhesive sheet with release sheet was obtained in the same manner as comparative example B4.

### Comparative Example B8

Apart from changing the solution of the pressure sensitive adhesive 2A-1 to the solution of the pressure-sensitive adhesive 2B-3, a double-faced pressure-sensitive adhesive sheet with release sheet was obtained in the same manner as comparative example B4.

(Evaluation)

Swelling prevention properties, curling prevention properties, punching workability, and properties of the conformance to irregularities of the double-faced pressure-sensitive adhesive sheet of the respective examples and the respective comparative examples were evaluated as follows. The evaluation results are shown in Table B1.

[Swelling Prevention Properties]

The third release sheet (the first release sheet in the case of comparative examples B1-B8) was removed, and a polycarbonate sheet (thickness: 1 mm) was bonded to the exposed pressure-sensitive adhesive layer, after which the second release sheet was removed, and a polyethylene terephthalate sheet (thickness: 100 μm) was bonded to the exposed pressure-sensitive adhesive layer to obtain a transparent laminate with a size of 100 mm×100 mm.

After pressure was applied to this transparent laminate for 30 minutes under conditions of a temperature of 50° C. and a pressure of 0.5 MPa in a pressurized defoaming apparatus (YK-350S, manufactured by Kurihara Seisakusho K.K.), it was left standing for 250 hours in an environment with a temperature of 60° C. and a relative humidity of 90%. Subsequently, the condition of the transparent laminate was visually observed, and evaluated according to the following standard.

A: no occurrence whatever of gas swelling

B: occurrence of fine bubbles (gas swelling) in small amounts

C: occurrence of gas swelling over the entire surface

[Curling Prevention Properties]

The samples used in evaluation of the aforementioned swelling prevention properties (transparent laminates that had been left standing for 250 hours in an environment with a temperature of 60° C. and a relative humidity of 90%) were laid horizontally on a flat surface, the heights of the four corners were measured, and the average value thereof was calculated. Curling prevention properties were evaluated from the pertinent average values according to the following standard.

A: 0 mm-0.15 mm

B: 0.15 mm-0.25 mm

C: 0.25 mm and above

[Punching Workability]

A prepared double-faced pressure-sensitive adhesive sheet was punched out from the third release sheet side (the first release sheet side in the case of comparative examples B1-B8) with a cutter provided with a pinnacle blade with a size of 50 mm×50 mm, and the cutting surface and cutting blade were evaluated according to the following standard.

AA: there is no bleeding of pressure-sensitive adhesive on the cutting surface, and no adhesion whatever of pressure-sensitive adhesive to the cutting blade

A: there is some bleeding of pressure-sensitive adhesive on the cutting surface, and no adhesion whatever of pressure-sensitive adhesive to the cutting blade

B: there is bleeding of pressure-sensitive adhesive on the cutting surface, and some adhesion of pressure-sensitive adhesive to the cutting blade

C: there is bleeding of pressure-sensitive adhesive on the cutting surface, and adhesion of pressure-sensitive adhesive to the cutting blade

[Properties of the Conformance to Irregularities]

To obtain a polyethylene terephthalate sheet with irregularities, printing was conducted on one surface of a polyethylene terephthalate sheet so that irregularities with a height difference of 30 μm were formed.

The third release sheet (the first release sheet in the case of comparative examples B1-B8) was removed, and a polyethylene terephthalate sheet without irregularities was bonded to the exposed pressure-sensitive adhesive layer, after which the second release sheet was removed, and the irregular surface of a polyethylene terephthalate sheet with irregularities was bonded to the exposed pressure-sensitive adhesive layer to obtain a transparent laminate.

Pressure was applied to this transparent laminate for 10 minutes under conditions of a temperature of 40° C. and a pressure of 0.5 MPa in a pressurized defoaming apparatus. The degree of adhesiveness of the polyethylene terephthalate sheet with irregularities was then observed using a microscope (magnification: 25-fold), and evaluated according to the following standard.

A: the uneven portions of the irregularities were completely filled up

B: small amounts of air remained in the uneven portions of the irregularities

C: air remained in the entirety of the uneven portions of the irregularities

TABLE B1

| | First | | Second | | Third | | | | | |
|---|---|---|---|---|---|---|---|---|---|---|
| | pressure-sensitive | | pressure-sensitive | | pressure-sensitive | | | | | Irregularity |
| | adhesive layer | | adhesive layer | | adhesive layer | | | | Punching | properties of |
| | Pressure | | Pressure | | Pressure | | Swelling | Curling | prevention | the |
| | sensitive | Thickness | sensitive | Thickness | sensitive | Thickness | prevention | prevention | properties | conformance to |
| | adhesive | (μm) | adhesive | (μm) | adhesive | (μm) | properties | properties | [sic] | irregularities |
| Example B1 | 2A-1 | 70 | 2B-1 | 15 | 2B-2 | 15 | A | A | AA | A |
| Example B2 | 2A-2 | 70 | 2B-1 | 15 | 2B-2 | 15 | A | A | AA | A |
| Example B3 | 2A-2 | 70 | 2B-3 | 15 | 2B-2 | 15 | A | A | AA | A |
| Example B4 | 2A-2 | 70 | 2B-2 | 15 | 2B-1 | 15 | A | A | AA | A |
| Comparative | 2A-1 | 75 | 2B-1 | 25 | — | — | B | A | A | A |
| example B1 | | | | | | | | | | |
| Comparative | 2A-2 | 75 | 2B-3 | 25 | — | — | C | A | A | A |
| example B2 | | | | | | | | | | |
| Comparative | 2A-2 | 75 | 2B-2 | 25 | — | — | C | A | A | A |
| example B3 | | | | | | | | | | |
| Comparative | 2A-1 | 100 | — | — | — | — | B | A | B | A |
| example B4 | | | | | | | | | | |
| Comparative | 2A-2 | 100 | — | — | — | — | C | A | C | A |
| example B5 | | | | | | | | | | |
| Comparative | 2B-1 | 100 | — | — | — | — | A | C | AA | C |
| example B6 | | | | | | | | | | |
| Comparative | 2B-2 | 100 | — | — | — | — | A | B | AA | B |
| example B7 | | | | | | | | | | |
| Comparative | 2B-3 | 100 | — | — | — | — | A | C | AA | C |
| example B8 | | | | | | | | | | |

### INDUSTRIAL APPLICABILITY

As the double-faced pressure-sensitive adhesive sheet of the present invention can prevent occurrence of swelling, has excellent conformance to irregularities, inhibits curling, and exhibits excellent work production during punching, it is useful, for example, in adhesion of a position input device and a front plate that is disposed on the front side of the pertinent position input device during manufacture of a touchscreen.

### DESCRIPTION OF THE REFERENCE NUMERALS

11: transparent laminate
110: double-faced pressure-sensitive adhesive sheet
111: first pressure-sensitive adhesive layer
112: second pressure-sensitive adhesive layer
120: double-faced pressure-sensitive adhesive sheet with release sheet
130a: first release sheet
130b: second release sheet
140: first transparent substrate
141: insulating substrate
142: conductive layer
143: electrode
150: transparent substrate
21: transparent laminate
210: double-faced pressure-sensitive adhesive sheet
211: first pressure-sensitive adhesive layer
212: second pressure-sensitive adhesive layer
213: third pressure-sensitive adhesive layer
220: double-faced pressure-sensitive adhesive sheet with release sheet
230a: first release sheet
230b: second release sheet
240: first transparent substrate
241: insulating substrate
242: conductive layer
243: electrode
250: second transparent substrate

1. A double-faced pressure-sensitive adhesive sheet, comprising a first pressure-sensitive adhesive layer, and a second pressure-sensitive adhesive layer provided on one side of said first pressure-sensitive adhesive layer, wherein a primary component of the first pressure-sensitive adhesive layer is a two-part acrylic pressure-sensitive adhesive (I), and a weight average molecular weight of said two-part acrylic pressure-sensitive adhesive (I) is 150,000-800,000, and wherein a primary component of the second pressure-sensitive adhesive layer is a two-part acrylic pressure-sensitive adhesive (II), and a weight average molecular weight of said two-part acrylic pressure-sensitive adhesive (II) is 900,000-2,000,000.

2. The double-faced pressure-sensitive adhesive sheet according to claim 1, wherein a weight average molecular weight of the two-part acrylic pressure-sensitive adhesive (I) is 350,000-800,000.

3. The double-faced pressure-sensitive adhesive sheet according to claim 1, wherein a thickness of the first pressure-sensitive adhesive layer is 1.5-fold to 100-fold of a thickness of the second pressure-sensitive adhesive layer.

4. The double-faced pressure-sensitive adhesive sheet according to claim 3, wherein a thickness of the first pressure-sensitive adhesive layer is 20-500 μm.

5. The double-faced pressure-sensitive adhesive sheet according to claim 3, wherein a thickness of the second pressure-sensitive adhesive layer is 5-50 μm.

6. A double-faced pressure-sensitive adhesive sheet with release sheet, wherein a release sheet is laminated onto at least one surface of the double-faced pressure-sensitive adhesive sheet according to claim 1.

7. A method of manufacture of the double-faced pressure-sensitive adhesive sheet with release sheet according to claim 6, comprising: a step in which coating color to form a first pressure-sensitive adhesive layer containing a crosslinking agent and an acrylic polymer with a weight of average molecular weight of 150,000-800,000 and coating color to form a second pressure-sensitive adhesive layer containing a crosslinking agent and an acrylic polymer with a weight average molecular weight of 900,000-2,000,000 are simultaneously multilayer coated onto a release sheet, and heating is conducted to form said double-faced pressure-sensitive adhesive sheet.

8. A transparent laminate in which a first transparent substrate and a second transparent substrate are bonded by the double-faced pressure-sensitive adhesive sheet according to claim 1, and in which the first pressure-sensitive adhesive layer contacts the first transparent substrate, and the second pressure-sensitive adhesive layer contacts the second transparent substrate, wherein at least one or the other of the first transparent substrate and the second transparent substrate have irregularities formed on a surface on the double-faced pressure-sensitive adhesive sheet side, and the second transparent substrate is any one of a polycarbonate monolayer sheet, a polymethyl methacrylate monolayer sheet, a polycarbonate-polymethyl methacrylate laminar sheet, a triacetyl cellulose sheet, or a cycloolefin polymer sheet.

9. The double-faced pressure-sensitive adhesive sheet according to claim 1, wherein a third pressure-sensitive adhesive layer is provided on a surface on the opposite side of the surface of the first pressure-sensitive adhesive layer on which the second pressure-sensitive adhesive layer is provided, and a primary component of said third pressure-sensitive adhesive layer is a two-part acrylic pressure-sensitive adhesive (III), a weight average molecular weight of the pertinent two-part acrylic pressure-sensitive adhesive (III) is 900,000-2,000,000, and a thickness of the second pressure-sensitive adhesive layer is 5-50 μm.

10. The double-faced pressure-sensitive adhesive sheet according to claim 9, wherein a thickness of the first pressure-sensitive adhesive layer is 1.5-fold to 100-fold of a thickness of the second pressure-sensitive adhesive layer.

11. The double-faced pressure-sensitive adhesive sheet according to claim 10, wherein a thickness of the first pressure-sensitive adhesive layer is 20-500 μm.

12. The double-faced pressure-sensitive adhesive sheet according to claim 9, wherein a thickness of the third pressure-sensitive adhesive layer is 5-50 μm.

13. A double-faced pressure-sensitive adhesive sheet with release sheet, wherein a release sheet is laminated onto at least one surface of the double-faced pressure-sensitive adhesive sheet according to claim 9.

14. A method of manufacture of the double-faced pressure-sensitive adhesive sheet with release sheet according to claim 13, comprising: a step in which coating color to form a first pressure-sensitive adhesive layer containing a crosslinking agent and an acrylic polymer with a weight of average molecular weight of 150,000-800,000, coating color to form a second pressure-sensitive adhesive layer containing a crosslinking agent and an acrylic polymer with a weight average molecular weight of 900,000-2,000,000, and coating color to form a third pressure-sensitive adhesive layer containing a crosslinking agent and an acrylic polymer with a weight average molecular weight of 900,000-2,000,000 are simultaneously multilayer coated onto a release sheet, and heating is conducted to form said double-faced pressure-sensitive adhesive sheet.

15. A transparent laminate in which a first transparent substrate and a second transparent substrate are bonded by the double-faced pressure-sensitive adhesive sheet according to claim 9, and in which the second pressure-sensitive adhesive layer contacts the first transparent substrate, and the third pressure-sensitive adhesive layer contacts the second transparent substrate; wherein at least one or the other of the first transparent substrate and the second transparent substrate have irregularities formed on a surface on the double-faced pressure-sensitive adhesive sheet side, and at least one or the other of the first transparent substrate and the second transparent substrate is composed of polycarbonate, polymethyl methacrylate, polyethylene terephthalate, triacetyl cellulose, or cycloolefin polymer.
